(19) United States
(12) Patent Application Publication
(10) Pub. No.: US 2015/0317193 A1
(43) Pub. Date: Nov. 5, 2015

(54) DISTRIBUTED PROCESSING APPARATUS, DISTRIBUTED PROCESSING SYSTEM, AND STORAGE MEDIUM

(71) Applicant: FUJITSU LIMITED, Kawasaki-shi (JP)

(72) Inventor: Munenori MAEDA, Yokohama (JP)

(73) Assignee: FUJITSU LIMITED, Kawasaki (JP)

(21) Appl. No.: 14/636,605

(22) Filed: Mar. 3, 2015

(30) Foreign Application Priority Data
Apr. 30, 2014 (JP) 2014-094093

(51) Int. Cl. G06F 9/54

(52) U.S. Cl. CPC G06F 9/547

(57) ABSTRACT

A distributed processing apparatus includes: a memory; and a processor coupled to the memory and configured to: store sequence information indicative of a sequence, in which a processing request for each of a plurality of processes is received from a request source apparatus, in the memory when the processing request for each of the plurality of processes is sequentially received from the request source apparatus and one of the distributed processing apparatus and an other apparatus executes each of the plurality of processes, and transmit a processing result of each of the plurality of processes to the request source apparatus according to the sequence indicated by the sequence information when the one of the distributed processing apparatus and the other apparatus completes each of the plurality of processes.

### CROSS-REFERENCE TO RELATED APPLICATION

This application is based upon and claims the benefit of priority of the prior Japanese Patent Application No. 2014-094093 filed on Apr. 30, 2014, the entire contents of which are incorporated herein by reference.

### FIELD

The embodiments discussed herein are related to a distributed processing apparatus, a distributed processing system, and a storage medium.

### BACKGROUND

In the related art, a technology called a remote procedure call (RPC), in which a process operated on a certain apparatus causes another apparatus to execute a process, is known. In addition, a technology which distributes processes to plural apparatuses using the RPC has been known. The RPC includes synchronous execution and asynchronous execution. When the synchronous execution is performed, a request source apparatus, which transmits plural process-processing requests, transmits a processing request for a certain process of plural processes to a request destination apparatus of the processing request, and transmits a processing request for a process subsequent to the certain process after receiving a processing result of the certain process from the request destination apparatus. In contrast, when the asynchronous execution is performed, the request source apparatus transmits the processing request for the certain process to the request destination apparatus, and transmits the processing request for the subsequent process to a certain apparatus without confirming the reception of the processing result of the certain process from the request destination apparatus.

For example, related art is known which suppresses an RPC response while driving an asynchronous process to secure a resource and perform an RPC process when an RPC request is received from a request source apparatus, and secure the resource again and transmits the suppressed response to the request source apparatus when the asynchronous process ends. In addition, related art is known in which a node which finds an error directly and reports the error to an initial request source apparatus and an intermediate node when the RPC is formed in a nest form.

Japanese Laid-open Patent Publication No. 2006-185229 and Japanese Laid-open Patent Publication No. 7-6139 have been known as examples of the related art.

### SUMMARY

According to an aspect of the invention, a distributed processing apparatus includes: a memory; and a processor coupled to the memory and configured to: store sequence information indicative of a sequence, in which a processing request for each of a plurality of processes is received from a request source apparatus, in the memory when the processing request for each of the plurality of processes is sequentially received from the request source apparatus and one of the distributed processing apparatus and an other apparatus executes each of the plurality of processes, and transmit a processing result of each of the plurality of processes to the request source apparatus according to the sequence indicated by the sequence information when the one of the distributed processing apparatus and the other apparatus completes each of the plurality of processes

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B illustrate an example of an operation performed by a distributed processing system;

FIG. 2 illustrates an example of connection of a distributed processing system;

FIG. 3 illustrates an example of the hardware configuration of node A;

FIG. 4 illustrates an example of the functional configuration of the node A;

FIG. 5 illustrates an example of transmission of an RFC call in the same destination;

FIG. 6 illustrates an example of transmission of multi-stage RPCs;

FIGS. 7A, 7B, and 7C illustrate an example of path information;

FIG. 8 illustrates an example of process content of a session execution unit;

FIG. 9 illustrates an example of a message format;

FIG. 10 illustrates an example of a response format;

FIG. 11 illustrates an example of content stored in a message management table;

FIG. 12 illustrates an example of content stored in a transmission waiting table;

FIG. 13 illustrates an example of the relationship between a client and a server in a two-stage hierarchy;

FIG. 14 illustrates an initial state before the execution of commands in the two-stage hierarchy;

FIG. 15 illustrates a state at time 0 after the execution of the commands starts in the two-stage hierarchy;

FIG. 16 illustrates a state at time 1 after the execution of the commands starts in the two-stage hierarchy;

FIG. 17 illustrates a state at time 2 after the execution of the commands starts in the two-stage hierarchy;

FIG. 18 illustrates a state at time 3 after the execution of the commands starts in the two-stage hierarchy;

FIG. 19 illustrates a state at time 4 after the execution of the commands starts in the two-stage hierarchy;

FIG. 20 illustrates a state at time 5 after the execution of the commands starts in the two-stage hierarchy;

FIG. 21 illustrates a state at time 6 after the execution of the commands starts in the two-stage hierarchy;

FIG. 22 illustrates a state at time 7 after the execution of the commands starts in the two-stage hierarchy;

FIG. 23 illustrates an example of the relationship between a client and a server in a three-stage hierarchy;

FIG. 24 illustrates an initial state before the commands are executed in the three-stage hierarchy;

FIG. 25 illustrates a state at time 0 after the execution of the commands starts in the three-stage hierarchy;

FIG. 26 illustrates a state at time 1 after the execution of the commands starts in the three-stage hierarchy;

FIG. 27 illustrates a state at time 2 after the execution of the commands starts in the three-stage hierarchy;

FIG. 28 illustrates a state at time 3 after the execution of the commands starts in the three-stage hierarchy;

FIG. 29 illustrates a state at time 4 after the execution of the commands starts in the three-stage hierarchy;

FIG. 30 illustrates a state at time 5 after the execution of the commands starts in the three-stage hierarchy;

FIG. 31 illustrates a state at time 6 after the execution of the commands starts in the three-stage hierarchy;

FIG. 32 illustrates a state at time 7 after the execution of the commands starts in the three-stage hierarchy;

FIG. 33 illustrates a state at time 8 after the execution of the commands starts in the three-stage hierarchy;

FIG. 34 illustrates a state at time 9 after the execution of the commands starts in the three-stage hierarchy;

FIG. 35 illustrates a state at time 10 after the execution of the commands starts in the three-stage hierarchy;

FIG. 36 illustrates a state at time 11 after the execution of the commands starts in the three-stage hierarchy;

FIG. 37 illustrates a state at time 12 after the execution of the commands starts in the three-stage hierarchy;

FIG. 38 illustrates a state at time 13 after the execution of the commands starts in the three-stage hierarchy;

FIG. 39 illustrates a state at time 14 after the execution of the commands starts in the three-stage hierarchy;

FIG. 40 illustrates a state at time 15 after the execution of the commands starts in the three-stage hierarchy;

FIG. 41 illustrates a state at time 16 after the execution of the commands starts in the three-stage hierarchy;

FIG. 42 illustrates a state at time 17 after the execution of the commands starts in the three-stage hierarchy;

FIG. 43 illustrates a state at time 18 after the execution of the commands starts in the three-stage hierarchy;

FIG. 44 illustrates a state at time 19 after the execution of the commands starts in the three-stage hierarchy;

FIG. 45 illustrates a state at time 20 after the execution of the commands starts in the three-stage hierarchy;

FIG. 46 illustrates an example of the order of judgment targets of path information when a message is transmitted;

FIGS. 47A and 47B illustrate an example of comparison of time which is taken from the start to completion of the command execution;

FIG. 48 is a flowchart illustrating an example of a message reception process procedure;

FIG. 49 is a flowchart illustrating an example of a message transmission process procedure;

FIG. 50 is a flowchart illustrating an example of the message transmission process procedure;

FIG. 51 is a flowchart illustrating an example of the message transmission process procedure;

FIG. 52 is a flowchart illustrating an example of a response transmission process procedure; and

FIG. 53 is a flowchart illustrating an example of a response reception process procedure.

### DESCRIPTION OF EMBODIMENTS

According to the related art, it is difficult to reduce the time which is taken to execute plural processes while ensuring that the order of the plural processes is not changed. For example, according to synchronous execution, it is guaranteed that the order of the plural processes is not changed but it takes time to receive a process result of an arbitrary process. In addition, according to asynchronous execution, the time taken to execute the plural processes is reduced but there is a case in which the order of an arbitrary process and a subsequent process is changed. In addition, according to the asynchronous execution, there is a problem in that a subsequent process result is received prior to the process result of a precedent process.

An object of the example is to provide a distributed processing apparatus, a distributed processing system, and a distributed processing program capable of reducing the time taken for plural processes while ensuring that the order is not changed.

Embodiments of the distributed processing apparatus, the distributed processing system, and the distributed processing program according to the disclosure will be described in detail below with reference to the accompanying drawings.

### First Embodiment

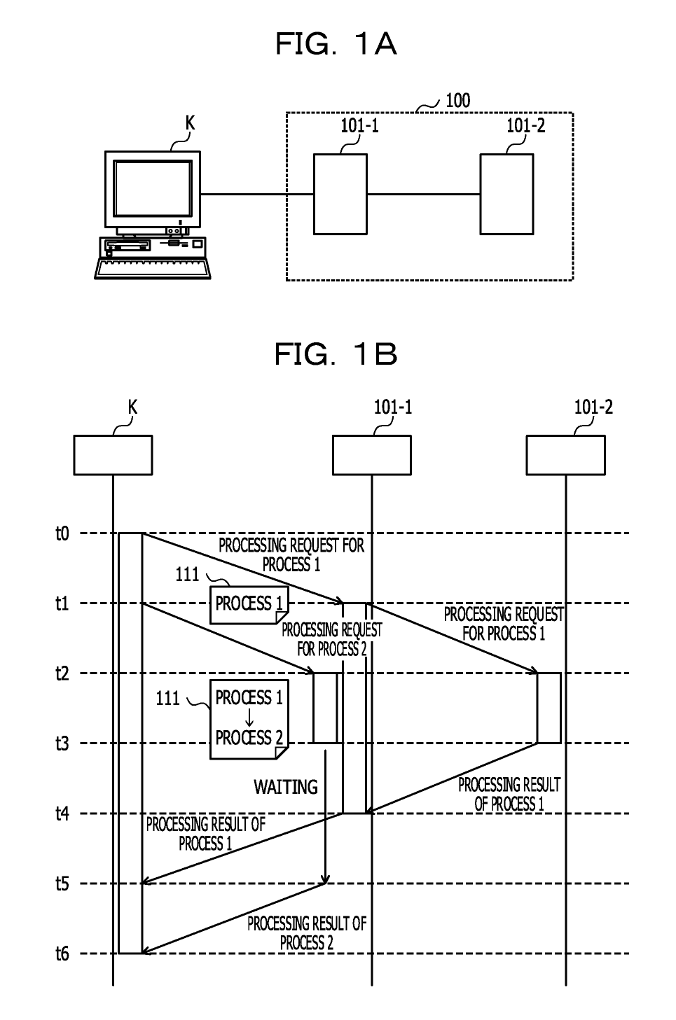

FIGS. 1A and 1B illustrate an example of an operation performed by a distributed processing system 100. As illustrated in FIG. 1A, distributed processing apparatuses 101-1 and 101-2, which are included in the distributed processing system 100 according to a first embodiment, are computers which execute a distributed process. The distributed processing system 100 illustrated in FIG. 1A is a system which performs distributed processing on a requested process using the distributed processing apparatuses 101-1 and 101-2. The distributed processing apparatuses 101-1 and 101-2 are, for example, servers. In addition, a client computer K is coupled to the distributed processing system 100 as a request source apparatus which transmits plural processing requests to the distributed processing apparatus 101-1. Hereinafter, for simplification of description, the client computer K is referred to as a “client K”. In addition, when the distributed processing apparatus 101-1 and the distributed processing apparatus 101-2 are not distinguished, there is a case in which the distributed processing apparatuses 101-1 and 101-2 are expressed as a distributed processing apparatus 101.

The distributed processing apparatus 101-1 asks the processing request which was requested by the client K to the distributed processing apparatus 101-2 through communication using a message. A technology called RPC is known as an example of the message communication. The RPC includes synchronous execution and asynchronous execution. When the synchronous execution is performed, a request source apparatus, which sequentially transmits processing requests for plural processes, transmits a processing request for a certain process of the plural processes to a request destination apparatus, and transmits a processing request for a subsequent process of the certain process after receiving the processing result of the certain process from the request destination apparatus. In contrast, when the asynchronous execution is performed, the request source apparatus transmits a processing request for a certain process to the request destination apparatus, and transmits a processing request for a subsequent process to the request destination apparatus without confirming the reception of the processing result of the certain process from the request destination apparatus.

In addition, the distributed processing apparatus 101-1 transmits the RPC from the client K to the distributed processing apparatus 101-2 as an RPC. As above, there is a case in which the RPC transmitted in an RPC process is called a “child RPC”. In addition, the distributed processing system 100 is in a distributed process environment in a two-stage hierarchy in which 2-stage RPC is performed.

Here, when the client K executes plural RPCs with regard to the distributed processing system 100, there is a case in which there is a dependent relationship between the plural RPCs and the execution sequence thereof is determined. An example in which there is the dependent relationship includes a case in which a first RPC updates a resource in the distributed processing system 100 and a second RPC refers to the resource in the distributed processing system 100. As above, when plural RPCs which have the dependent relationship are executed, the client K causes the execution sequence not to be changed when the plural RPCs are executed by synchronous execution.

However, in the synchronous execution, after a processing result of a certain process is received from the distributed processing system, a processing request for a subsequent process of the certain process is transmitted. Therefore, it takes long time for executing plural processes. In contrast, when the asynchronous execution is used, it takes a shorter time for executing the plural processes compared to the synchronous execution but it is difficult to guarantee the execution sequence of the plural processes.

Here, the distributed processing apparatus 101-1 according to the embodiment stores the reception order of each RPC processing request which is sequentially received from the client K, and transmits the result of each RPC process to the client K according to the reception order when each RPC process is completed. Therefore, the distributed processing apparatus 101-1 may reduce the time taken for the plural RPC processes while guaranteeing that the order of the plural RPC processes is not changed.

The progress of a process between the client K and the distributed processing system 100 will be described with reference to FIG. 1B. The client K causes the distributed processing apparatus 101 to execute a process 1 and a process 2 as plural processes. Further, it is assumed that the distributed processing apparatus 101-2 executes the process 1 and the distributed processing apparatus 101-1 executes the process 2. Here, a process which is executed by an apparatus in the distributed processing system 100 may be determined by the client K or may be determined by an apparatus which receives an RPC of the client K.

The client K transmits a processing request for the process 1 to the distributed processing apparatus 101-1 using an RPC through the asynchronous execution at time t0. Subsequently, when the distributed processing apparatus 101-1 receives the processing request for the process 1 at time t1, the distributed processing apparatus 101-1 stores the fact that the process 1 is initially received in sequence information 111, and causes the distributed processing apparatus 101-2 to execute the process 1 using the child RPC through the synchronous execution. In addition, the client K transmits a processing request for the process 2 to the distributed processing apparatus 101-1 using the RPC through the asynchronous execution at time t1.

When the distributed processing apparatus 101-1 receives a processing request for the process 2 at time t2, the distributed processing apparatus 101-1 stores the fact that the process 2 is received subsequent to the process 1 in the sequence information 111, and executes the process 2. In addition, when the distributed processing apparatus 101-2 receives the processing request for the process 1 at time t2, the distributed processing apparatus 101-2 executes the process 1.

When the distributed processing apparatus 101-2 completes the process 1 at time t3, the distributed processing apparatus 101-2 transmits the processing result for the process 1 to the distributed processing apparatus 101-1 as a response of the RPC. In addition, when the distributed processing apparatus 101-1 completes the process 2 at time t3, the distributed processing apparatus 101-1 decides whether or not to transmit the processing result of the process 2 to the client K. Since the processing result of the process 1 which is prior to the process 2, which is indicated by the sequence information 111 is not transmitted at time t3, the distributed processing apparatus 101-1 waits without transmitting the processing result of the process 2.

When the distributed processing apparatus 101-1 receives the processing result of the process 1 at time t4, the distributed processing apparatus 101-1 transmits the processing result of the process 1 to the client K, and continuously transmits the processing result of the process 2 to the client K at time t5. In addition, the client K receives the processing result of the process 1 at time t5, and continuously receives the processing result of the process 2 at time t6. As above, the distributed processing system 100 does not change the order of the process 1 and the process 2 using the RPC through the asynchronous execution, and may reduce the time taken for the process 1 and process 2 further than a case in which the synchronous execution is performed.

### Second Embodiment

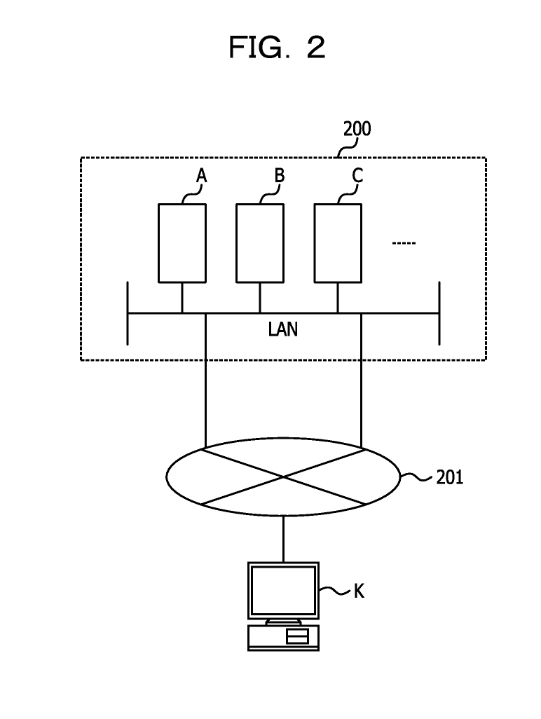

Subsequently, a system which performs a distributed process in a distributed process environment having a three or more-stage hierarchy will be described with reference to FIG. 2.

FIG. 2 illustrates an example in which a distributed processing system 200 is connected. The distributed processing system 200 illustrated in FIG. 2 includes nodes A, B, C, . . . , . The nodes A, B, C, . . . , correspond to the distributed processing apparatus 101 illustrated in FIG. 1A. The distributed processing system 200 is a system which performs distributed processing using a computer group which is formed in three or more-stage hierarchy using nodes A, B, C, . . . . The nodes A, B, C, . . . , are coupled to each other through a local area network (LAN). In addition, the distributed processing system 200 is coupled to the client computer K through a network 201. The nodes A, B, C, . . . , correspond to the distributed processing apparatus 101 illustrated in FIG. 1A. The nodes A, B, C, . . . are computers which execute distributed processing. The client K is a computer which uses the distributed processing system 200.

There is a case in which node A, which receives an RPC call from the client K, transmits the child RPC to the node B and the node B executes another RPC with regard to the node C while executing the child RPC. As above, the distributed processing system 200 performs grandchild RPCs, which is acquired by extending the child RPC, or general multi-stage RPCs. That is, the distributed processing system 200 is a distributed processing environment having a three or more-stage hierarchy in which three or more-level RPCs are performed.

In the multi-stage RPCs, there is a case in which it is difficult to secure security by only guaranteeing the execution sequence on RPC transmission and reception sides. For example, in distributed processing which extends to plural nodes, a global waiting mechanism is not prepared. Therefore, it is difficult to guarantee the execution sequence of two processes. Here, even though the global waiting mechanism is prepared, an apparatus which executes two processes inquires about the global waiting mechanism, with the result that various processes are successively processed, and thus an advantage of the distributed processing is lost.

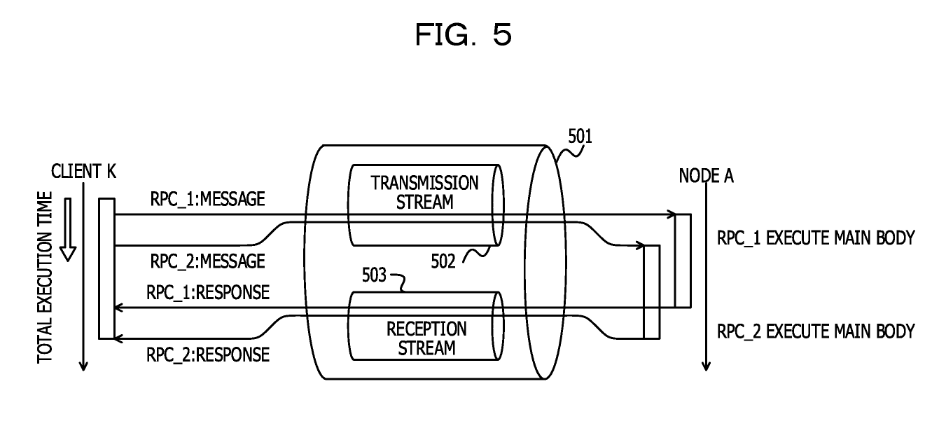

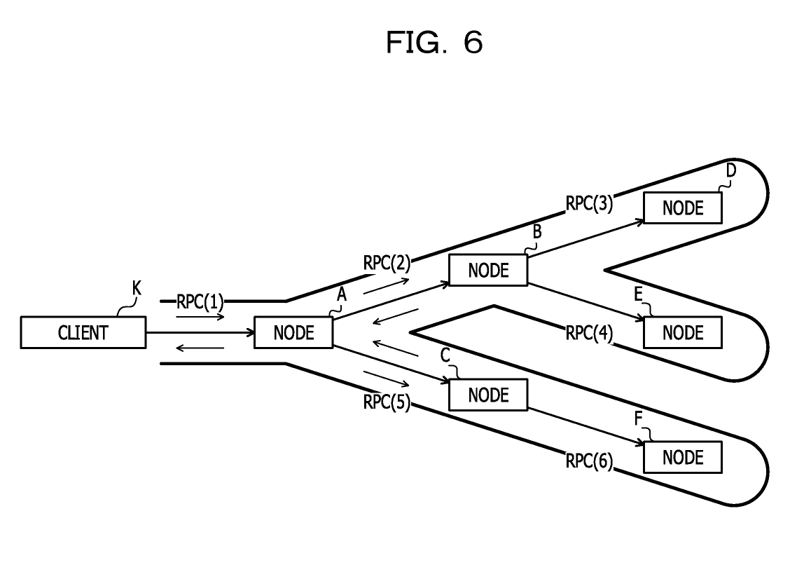

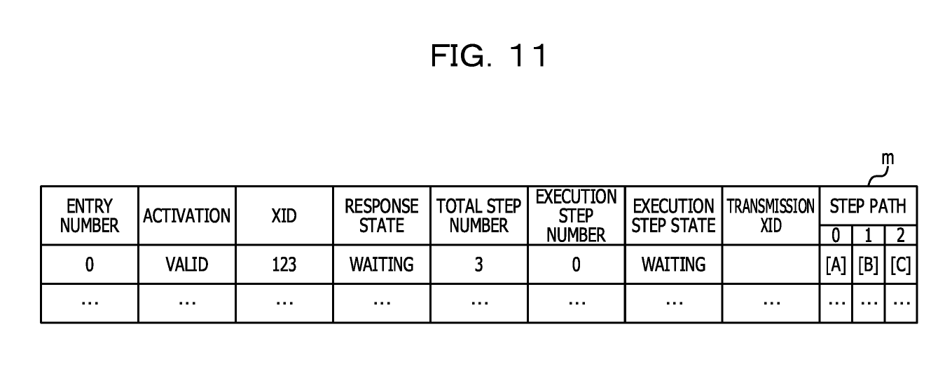

The distributed processing system 200 according to the embodiment performs three operations below in order to guarantee the execution sequence without losing the advantage of the distributed processing. A first operation is to guarantee a call sequence using a communication protocol for guaranteeing that data is received according to sequence, in which the data is transmitted, when the call destinations of plural RPC calls are the same. An example of transmission of the RPC calls to the same destination will be described with reference to FIG. 5. A second operation is to treat multi-stage RPCs as a series of RPCs. An example of transmission of the multi-stage RPCs will be described with reference to FIG. 6. A third operation is to perform waiting control using a message management table when there is a node which executes plural RPCs. The detailed content stored in the message management table will be described with reference to FIG. 11.

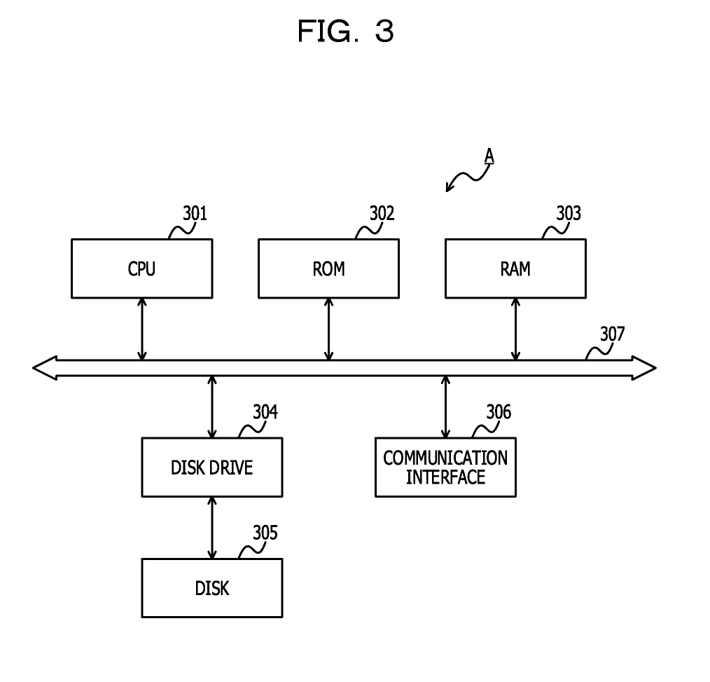

FIG. 3 illustrates an example of the hardware configuration of the node A. In FIG. 3, the node A includes a central processing unit (CPU) 301, a read only memory (ROM) 302, and a random access memory (RAM) 303. In addition, the node A includes a disk drive 304, a disk 305, and a communication interface 306. In addition, the CPU 301, the ROM 302, the RAM 303, the disk drive 304, the disk 305, and the communication interface 306 are coupled to each other through a bus 307.

The CPU 301 is an arithmetic processing unit which controls the entire node A. The ROM 302 is a nonvolatile memory which stores a program such as a booting program. The RAM 303 is a volatile memory which is used as the work area of the CPU 301.

The disk drive 304 is a control device which performs control such that data is read from or written into the disk 305 according to the control of the CPU 301. For example, a magnetic disk drive, a solid-state drive or the like may be used as the disk drive 304. The disk 305 is a nonvolatile memory which stores data that is written under the control of the disk drive 304. For example, when the disk drive 304 is a magnetic disk drive, it is possible to use a magnetic disk as the disk 305. In addition, when the disk drive 304 is a solid-state drive, it is possible to use a semiconductor memory, which is formed of a semiconductor element, so-called a semiconductor disk, as the disk 305.

The communication interface 306 is a control device which manages a network and an internal interface and controls the input and output of data from another apparatus. The communication interface 306 is coupled to another apparatus through a network over a communication line. For example, it is possible to use a modem, a LAN adapter or the like as the communication interface 306.

In addition, when a manager of the distributed processing system 100 directly operates the node A, the node A may include hardware such as a display, a keyboard, and a mouse. In addition, the nodes B, C, . . . may include the same hardware as the node A. The client K includes hardware, such as a display, a keyboard, and a mouse, in addition to the same hardware as the node A.

Example of Functional Configuration of Node A

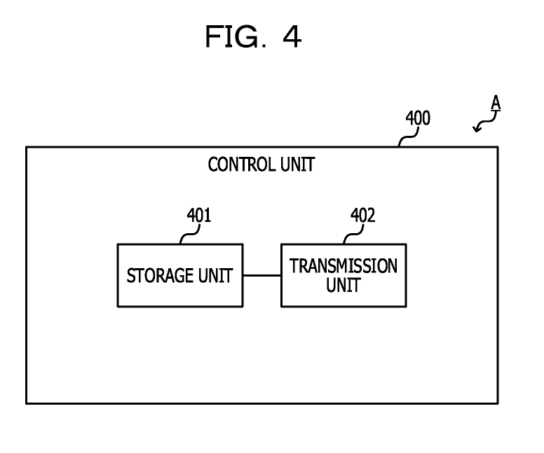

FIG. 4 illustrates an example of the functional configuration of the node A. The node A includes a control unit 400. The control unit 400 includes a storage unit 401 and a transmission unit 402. The control unit 400 realizes the function of the control unit 400 in such a way that the CPU 301 executes a program which is stored in a storage device. The storage device includes, for example, the ROM 302, the RAM 303, and the disk 305 which are illustrated in FIG. 3. In addition, the processing result of each of the units is stored in a register included in the CPU 301, the RAM 303, or the like.

The storage unit 401 stores the sequence information 111 when the processing request for each of the processes of plural processes is sequentially received from the client K and each of the processes is executed in any one of the node A, which is a main device, and the nodes B, C, . . . which are other devices. The sequence information 111 is information indicative of sequence in which the processing request for each of the processes is received from the client K.

The transmission unit 402 transmits the processing result of each of the processes to the client K according to the sequence, which is indicated in the sequence information 111 when any one of the nodes A, B, C, . . . completes each of the processes. More specifically, if a process, which is prior to each of the processes specified in the sequence information, is completed the transmission unit 402 transmits the processing result of each of the processes to the client K. In contrast, if a prior process is not completed, the transmission unit 402 transmits the processing result of each of the processes to the client K after the prior process is completed and the processing result of the prior process is transmitted to the client K.

In addition, when the transmission unit 402 receives the processing request for each of the processes, the transmission unit 402 may transmit the processing request for each of the processes to the above node if a node, which is executing the process prior to each of the processes specified in the sequence information 111, is the same as a node which executes each of the processes. The node which is executing a process and a node which executes a process will be described in detail with reference to FIG. 11.

In addition, it is assumed that the node A receives the processing request for each of the processes. In this case, the transmission unit 402 determines whether or not a single node, which is executing a partial process acquired by distributing the process prior to each of the processes specified in the sequence information 111, is the same as a head (preferential) node of a node group which executes each of the processes in a distributed manner. If the nodes are the same, the transmission unit 402 may transmit the processing request for the partial process, which is acquired by distributing each of the processes, to the above nodes.

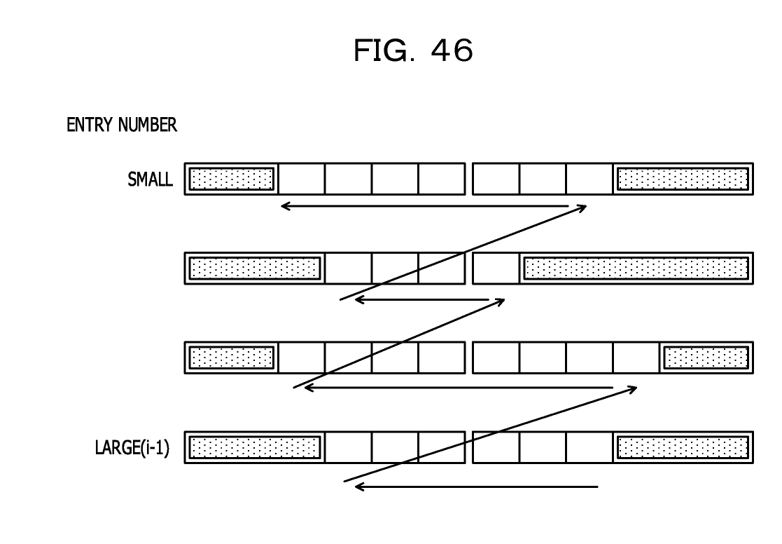

In addition, it is assumed that the node A receives the processing request for each of the processes. In this case, the transmission unit 402 determines whether or not there is a device which is included in both a first node group, which is executing the process prior to each of the processes specified in the sequence information 111, in a distributed manner, and a second node group which executes each of the processes in a distributed manner. If there is no node which is included in both the first node group and the second node group, a processing request for a partial process, which is acquired by distributing each of the processes to the second node group, may be transmitted. An example of the first node group and the second node group will be described in detail with reference to FIG. 46.

In addition, the transmission unit 402 transmits the processing request for each of the processes to any one of the node B, C, . . . using the communication protocol for guaranteeing that data is received according to sequence, in which the data is transmitted, and causes any one of the node B, C, . . . to execute each of the processes. In addition, the control unit 401 may use the above communication protocol when the processing request for each of the plural processes is sequentially received from the client K or when the processing result of each of the processes is transmitted to the client K according to the sequence indicated in the sequence information 111. An example of the communication protocol will be described in detail with reference to FIG. 5.

FIG. 5 illustrates an example of transmission of RPC calls to the same destination. In FIG. 5, description will be made based on an example in which the client K is an RPC transmission side and the node A is an RPC reception side. When RPC calls are provided to the same destination, the distributed processing system 200 provides the RPC calls and RPC responses using the communication protocol for guaranteeing that data is received according to sequence in which the data is transmitted. For simplification of description, there is a case in which the RPC call is called a “message” and the RPC response is called a “response” in the description below.

The communication protocol for guaranteeing that data is received according to sequence, in which the data is transmitted, is, for example, Transmission Control Protocol (TCP)/Internet Protocol (IP). For example, the TCP defines that data sequence control is performed based on a sequence number which is given to transmitted data.

More specifically, each of the devices of the distributed processing system 200 transmits an RPC call and an RPC response according to the session of the above communication protocol. Here, the session is a communication path which is bidirectional and in which the sequence of transmission and reception is guaranteed. For example, the session is TCP/IP stream.

FIG. 5 illustrates an example of transmission of two messages of an RPC_1 and an RPC_2. Since the destinations of the RPC_1 and the RPC_2 are the same, the client K transmits the RPC_1 and the RPC_2 using the same session 501. More specifically, the client K sequentially transmits the message of the RPC_1 and the message of the RPC_2 to the node A using a transmission stream 502 in the session 501. Since sequence is guaranteed in the transmission stream 502, the node A may sequentially receive the message of the RPC_1 and the message of the RPC_2.

In addition, the node A executes the main body processes of the RPC_1 and the RPC_2, and sequentially transmits the responses of the RPC_1 and the RPC_2 to the client K using a reception stream 503 in the session 501 when the main body processes of the RPC_1 and the RPC_2 are completed. Since the sequence is guaranteed in the reception stream 503, the client K may receive the responses of the RPC_1 and the RPC_2.

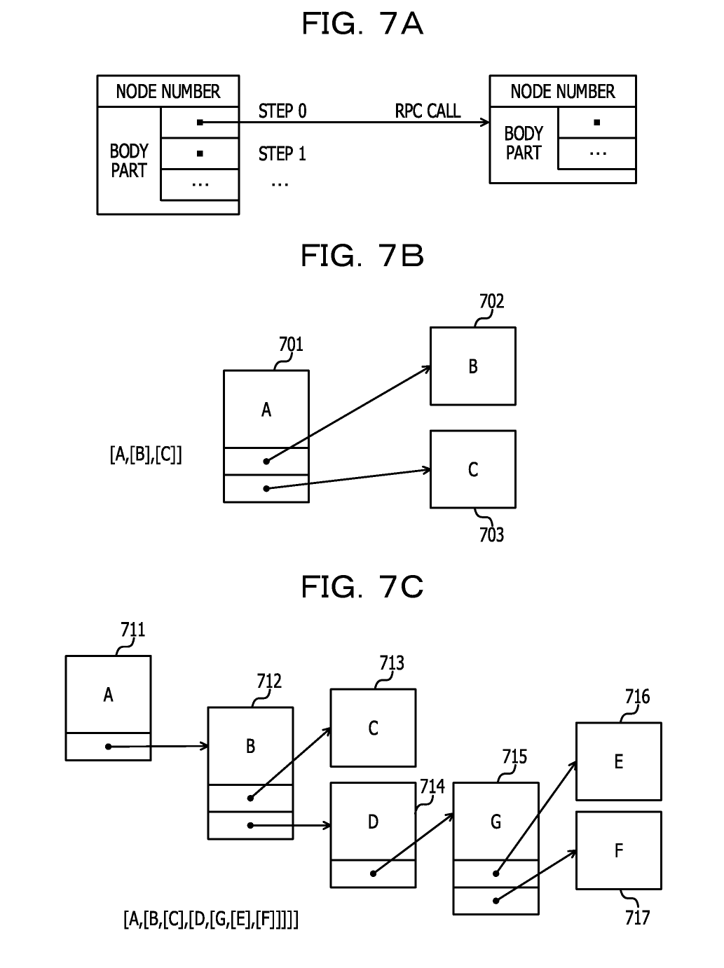

FIG. 6 illustrates an example of transmission of multi-stage RPCs. The distributed processing system 200 treats the multi-stage RPCs as a series of RPCs in order to guarantee safe execution sequence. FIG. 6 illustrates an example in which RPCs (2) to (6) derive from an RPC (1) transmitted from the client K. In the description below, an RPC group, which derives from the RPC transmitted from the client K, is called a “command”. Here, RPC (1) includes path information for specifying nodes B to F which consider the RPCs (2) to (6) as processing targets. The path information will be described with reference to FIGS. 7A, 7B, and 7C. In addition, the RPC (2) includes path information for specifying the nodes D and E which consider the RPCs (3) and (4) as processing targets. In the same manner, the RPC (5) includes path information for specifying the node F which considers the RPC (6) as a processing target.

FIGS. 7A, 7B, and 7C illustrate an example of the path information. As illustrated in FIG. 7A, the path information is information that includes the node number and the body part of an RPC call destination which is a start point. A single node is designated for the start point. The body part stores information for providing the RPC call from a node which is registered in the node number of the RPC call destination. A single RPC, which is called from the node registered in the node number of the RPC call destination, is called a “step”. The path information is stored in each step. As above, the path information is recursively defined. In addition, a path which is indicated by the path information has a tree structure.

FIGS. 7B and 7C illustrate detailed examples of the path information. Path information 701 [A,[B],[C]] illustrated in FIG. 7B includes the node A as an RPC start point, and includes two steps, that is, a step 0 and a step 1. Path information 702, which is the step 0, includes the node B as the start point and includes no step. Path information 703, which is the step 1, includes the node C as the start point and includes no step.

Path information 711 [A,[B,[C],[D,[G,[E],[F]]]]] illustrated in FIG. 7C includes an RPC start point of the node A and a single step having a step 0. Path information 712, in which a start point is the step 0 of the node A, includes a start point of the node B and two steps having the step 0 and the step 1. Path information 713, in which a start point is the step 0 of the node B, includes a start point of the node C with no step. Path information 714, in which a start point is the step 1 of the node B, includes a start point of the node D and a single step having the step 0. Path information 715, in which a start point is the step 0 of the node D, includes a start point of the node G and two steps having the step 0 and the step 1. Path information 716, in which a start point is the step 0 of the node G, includes a start point of the node E with no step. Path information 717, in which a start point is the step 1 of the node G, includes a start point of the node F with no step.

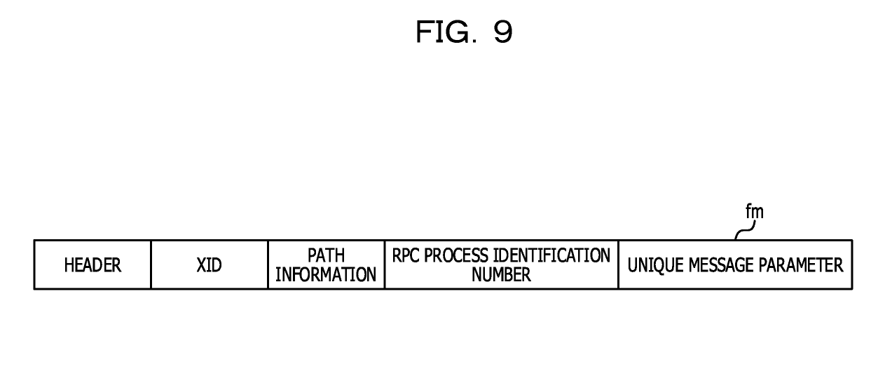

In addition, the path information is determined based on the RPC process identification number of a message, which is described with reference to FIG. 9, and the content of a unique message parameter. A detailed determination method will be described with reference to FIG. 9.

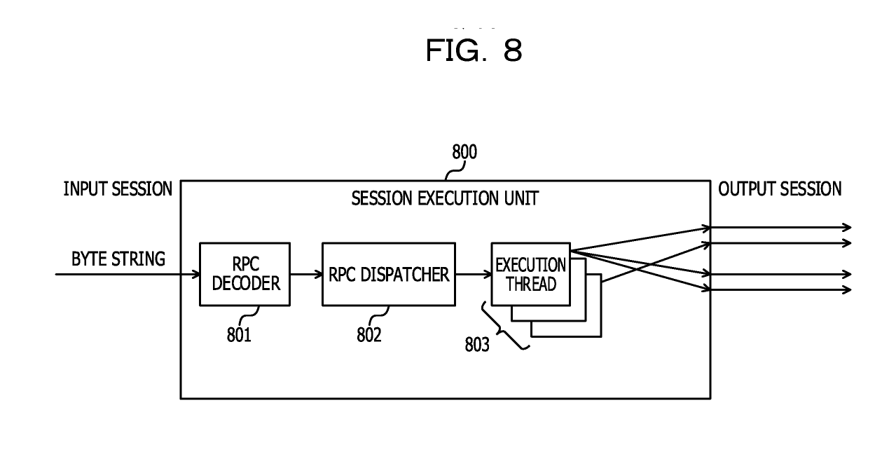

FIG. 8 illustrates an example of the content of a process performed by the session execution unit. The session execution unit 800 is a process which is generated for each input session. The session execution unit 800 includes an RPC decoder 801, an RPC dispatcher 802, and an execution thread 803. Plural session execution units 800 are generated in each node. The RPC decoder 801 decodes a byte string, which is received in the input session, and acquires RPCs. The RPC dispatcher 802 allocates the RPCs, which are acquired through decoding, to the execution thread 803. The execution thread 803 executes the RPCs. Plural execution threads 803 are present and execute the RPCs in parallel. There is a case in which the execution thread 803 transmits the RPCs from an output session while the execution thread 803 is executing the RPCs.

FIG. 9 illustrates an example of a message format. FIG. 9 illustrates a message format fm. The format fm includes a header field, an XID field, a path information field, an RPC process identification number field, and a unique message parameter field. The data size of the message is stored in the header field. More specifically, the entire data size of the message or the data size of each field is stored as the data size of the message. In addition, additional information other than the data size of the message is stored in the header field.

An XID, which is an identification number given to each message, is stored in the XID field. The XID may be any value if the value is unique by each session. The path information, which is illustrated in FIGS. 7A, 7B, and 7C, is stored in the path information field. An example of content stored in the path information is the content illustrated in 7A, 7B, and 7C. An RPC process identification number, which is relevant to an RPC operation such as WRITE and READ, is stored in the RPC process identification number field.

A list of parameter value for a message which is defined for each RPC process identification number is stored in the unique message parameter field. As an example, a pair of a key and a value is stored in the unique message parameter field. Here, it is possible to determine the path information based on a key in the unique message parameter field and the RPC process identification number. In addition, an execution subject, which determines the path information, may be the client K or may be a node which receives an RPC from the client K. For example, it is assumed that the RPC process identification number is WRITE, the unique message parameter is “key is a file name”, and a value is a writing target data. For example, a node which receives an RPC from the client K recognizes that the RPC process identification number is WRITE, and determines a node in a write destination based on a value which is acquired by inputting a file name to a hash function. The node in the write destination is included in the path information.

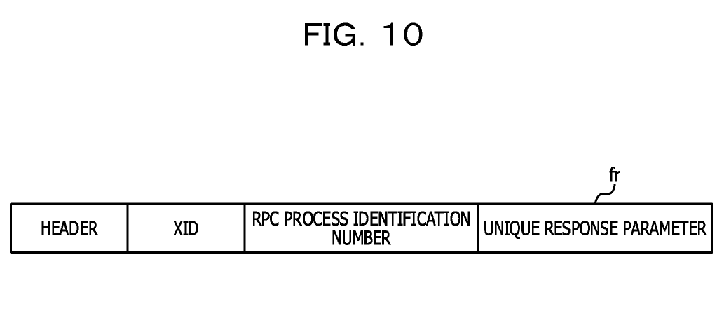

FIG. 10 illustrates an example of a response format. FIG. 10 illustrates a response format fr which is a response to the message. The format fr includes a header field, an XID field, an RPC process identification number field, and a unique response parameter field. The data size of the response is stored in the header field. More specifically, the entire data size of the response or the data size of each field is stored as the data size of the response. In addition, additional information other than the data size of the response is stored in the header field.

An XID, which is set to a message corresponding to a response, is stored in the XID field. An RPC process identification number, which is related to an RPC operation such as WRITE or READ, is stored in the RPC process identification number field. A list of parameter value for a response, which is defined for each RPC process identification number, is stored in the unique response parameter field.

FIG. 11 illustrates an example of content stored in a message management table. FIG. 11 illustrates an example of content stored in a message management table m. The message management table m is prepared for each input session. The RPC decoder registers an entry in the message management table m in order of reception of the message based on a message which is decoded. It is possible to remove the entry of the message management table after the process of the corresponding RPC ends. Meanwhile, hereinafter, the entry remains as an “invalid” entry while not being removed after the RPC ends in order to simplify the description of the embodiment.

The message management table m includes an entry number field, an activation field, an XID field, a response state field, a total step number field, an execution step number field, an execution step state field, a transmission XID field, and a step path field.

A number of the entry is stored in the entry number field. The number of the entry corresponds to the sequence information 111 illustrated in FIG. 1. An identifier which indicates whether or not the entry is valid is stored in the activation field. More specifically, when the entry is valid, an identifier “valid” is stored in the activation field. In contrast, when the entry is invalid, an identifier “invalid” is stored in the activation field. In addition, the identifier “invalid” is stored in the activation field at a registration point.

The XID of the message is stored in the XID field. An identifier, which indicates the state of the response, is stored in the response state field. More specifically, the identifier “invalid” is stored in the response state field at the registration point. In contrast, in a state in which it is possible to transmit a response state, an identifier “transmittable” is stored in the response state field.

The number of steps of the path information in the message is stored in the total step number field. The number of steps, which are being executed, from among the path information in the message is stored in the execution step number field. In addition, “0” is stored in the execution step number field at a registration point.

An identifier which indicates the state of the step number that is being executed is stored in the execution step state field. More specifically, an identifier “waiting” is stored in the execution step state field at a registration point. In contrast, in a state in which a message is being transmitted to a path corresponding to a value stored in the execution step number field, an identifier “being transmitted” is stored. Further, when a response with regard to the message is received, the identifier “waiting” is stored in the execution step state field when the value of the execution step number field increases by 1. That is, the identifier “waiting” and the identifier “being transmitted” are alternately stored in the execution step state field.

The XID of the transmitted message is stored in the transmission XID field. The transmission XID field is a field which contains meaning when the execution step state is “being transmitted”. In formation, which is acquired by analyzing the path information of the message for each step, is stored in the step path field. More specifically, the respective sub fields of the step path field store pieces of path information acquired through division from index 0 to total step number-1 of the path information of the message.

For example, a 0-th entry illustrated in FIG. 11 is acquired by registering a message in which the path information received by the client K is [K,[A],[B],[C]] and the XID is 123. Hereinafter, for simplification of description, there is a case in which an x-th entry of the message management table m is written as “ENT(x)”. In addition, there is a case in which each field of the x-th entry is written as “ENT(x). field name”. For example, the XID of the 0-th entry illustrated in FIG. 11 is written as ENT(0). XID=“123”.

In addition, it is determined whether or not each step of the step path field is executing a command or starts to execute from now based on the total step number field, the execution step number field, and the execution step state field. When the execution step state is “being transmitted”, a node group which is included in the step corresponding to the execution step number is a node which is executing the command. In addition, a node group, included in the step which is larger than the execution step number, is a node which starts to execute the command from now.

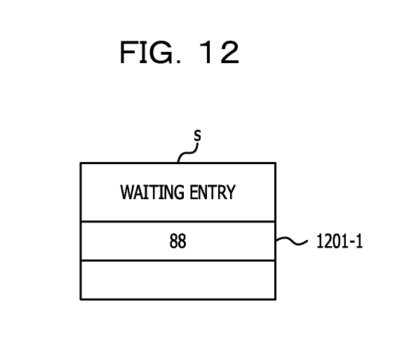

FIG. 12 illustrates an example of content stored in the transmission waiting table. A transmission waiting table s is a table which stores a transmittable entry number from among entries which are registered in the message management table m. Each of the nodes includes the transmission waiting table s. For example, the 0-th record 1201-1 of the transmission waiting table s illustrated in FIG. 12 indicates that a response corresponding to an entry number 88, which is registered in the message management table m, is transmittable.

Example of Two-Stage Hierarchy

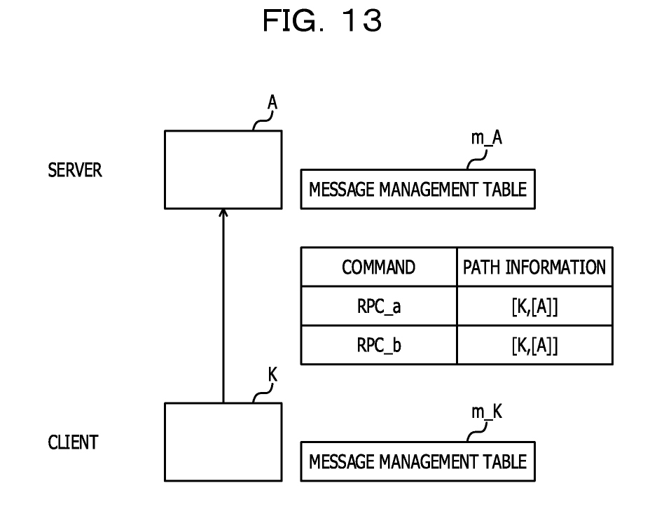

FIG. 13 illustrates an example of the relationship between a client and a server in a two-stage hierarchy. FIGS. 13 to 22 illustrate an example, in which the node A that is a server receives a command RPC_a and a command RPC_b from the client K and executes the commands, as a first example. The node A receives the command RPC_b after receiving the command RPC_a. In FIGS. 13 to 22, the path information of the command RPC_a and the RPC_b is [K,[A]]. In addition, in the example of FIGS. 13 to 22, RPC transmission time between the nodes is set to 1 unit time, time in which the node A completes the process of the command RPC_a is set to two unit time, and time in which the node A completes the process of the command RPC_b is set to 1 unit time.

As illustrated in FIG. 13, each of the node A, which is the server, and the client K, which is the client, includes a message management table m_A and a message management table m_K. As above, the client may include the message management table m. Further, when the client executes RPCs with regard to different servers, it is possible to wait for in the client using the message management table m. Since the client does not transmit a response, the XID field and the response state field of the message management table m included in the client is not used.

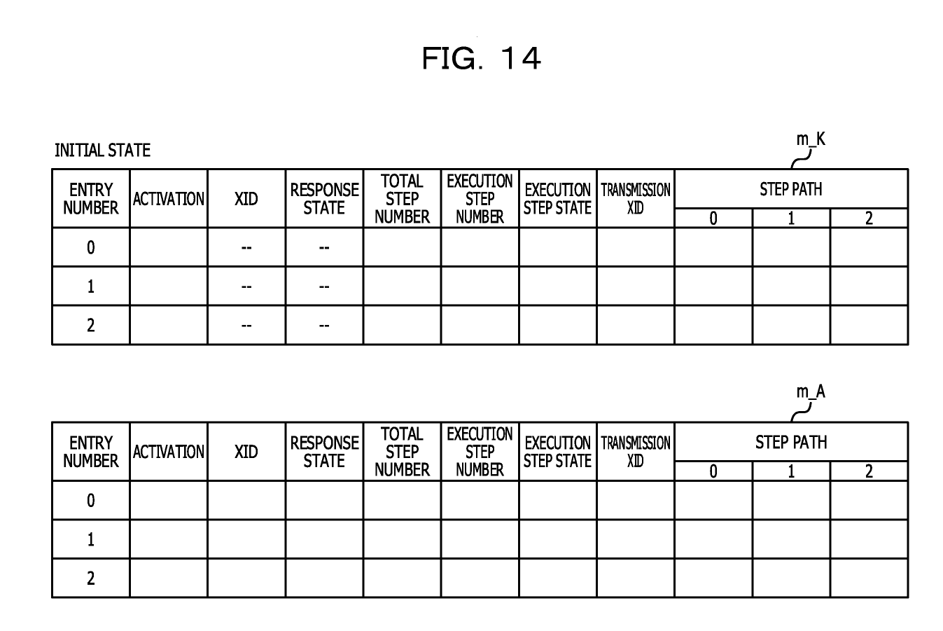

FIG. 14 illustrates an initial state before commands are executed in the two-stage hierarchy. FIG. 14 illustrates an initial state before commands RPC_a and RPC_b are executed in the two-stage hierarchy. As illustrated in FIG. 14, the message management tables m_K and m_A are empty in the initial state.

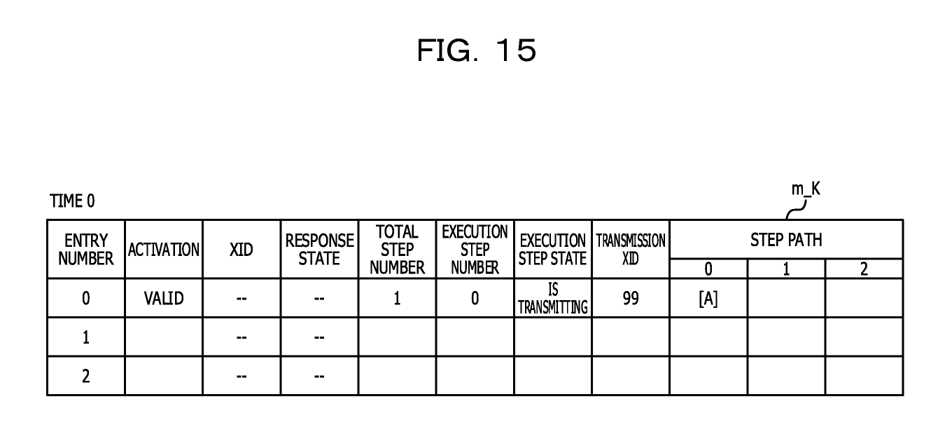

FIG. 15 illustrates a state at time 0 after the execution of the commands starts in the two-stage hierarchy. FIG. 15 illustrates a state in which time is time 0 and the client K transmits a message XID=99 to the node A as the processing request for the command RPC_a.

The message management table m_A at time 0 is the same as in FIG. 14. With regard to the message management table m_K at time 0, the client K registers the message XID=“99” in the message management table m_K as a 0-th entry. More specifically, the client K makes setting such that ENT(0). activation=“valid”, ENT(0). total step number=“1”, ENT(0). execution step number=“0”, ENT(0). execution step state=“is transmitting”, and ENT(0). transmission XID=“99”. In addition, the client K sets [A], which corresponds to the index 0 of the path information of the command RPC_a, to ENT(0). step path[0].

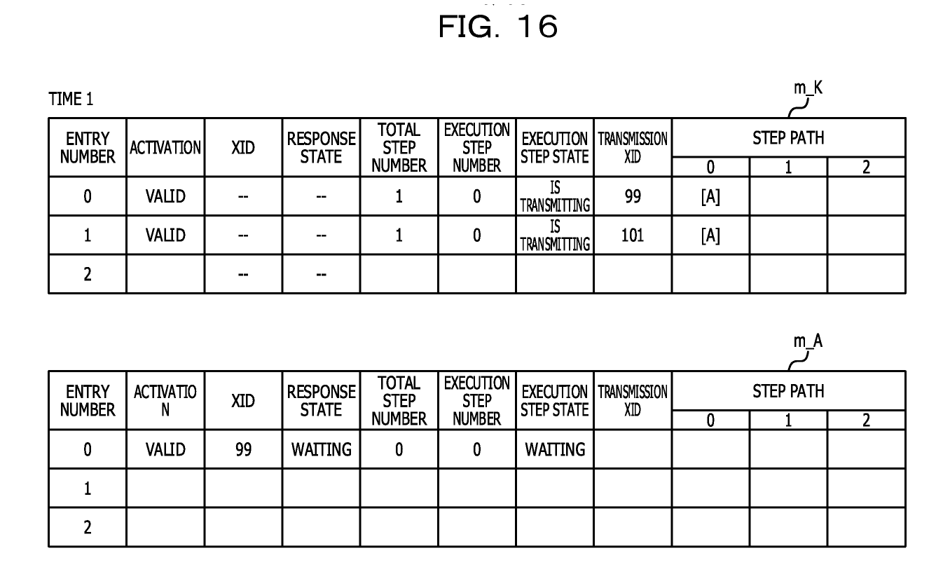

FIG. 16 illustrates a state at time 1 after the execution of the commands starts in the two-stage hierarchy. FIG. 16 illustrates a state in which the time is time 1 which elapses from time 0 by 1 time unit, the client K transmits a message XID=“101” to the node A as the execution of the command RPC_b, and the node A receives the message XID=“99”. Since the destinations of the message XID=“99” and the message XID=“101” are the same, the client K transmits the message XID=“101” in the same session as a session in which the message XID=“99” is transmitted.

With regard to the message management table m_K at time 1, the client K registers the message XID=“101” in the message management table m_K as a first entry. More specifically, the client K makes setting such that ENT(1). activation=“valid”, ENT(1). total step number=“1”, ENT(1). execution step number=“0”, ENT(1). execution step state=“is transmitting”, and ENT(1). transmission XID=“101”. In addition, the client K sets [A], which corresponds to the index 0 of the path information of the command RPC_b, to ENT(1). step path[0].

In addition, with regard to the message management table m_A at time 1, the node A registers the message XID=“99” in the message management table m_A as a 0-th entry. More specifically, the node A makes setting such that ENT(0). activation=“valid”, ENT(0). XID=“99”, ENT(0). response state=“waiting”, ENT(0). total step number=“0”, ENT(0). execution step number=“0”, and ENT(0). execution step state=“waiting”. In addition, the node A starts a process for the command RPC_a at time 1.

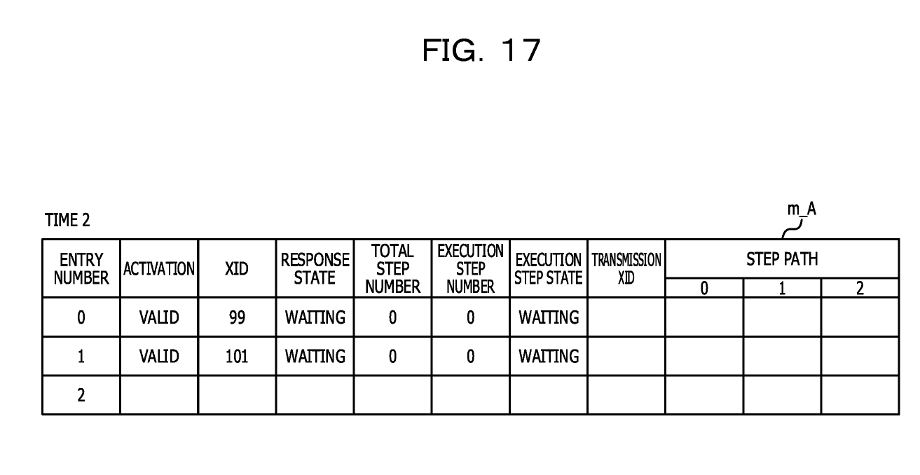

FIG. 17 illustrates a state at time 2 after the execution of the commands starts in the two-stage hierarchy. FIG. 17 illustrates a state in which the node A receives the message XID=“101” at time 2 which elapses from time 1 by 1 time unit.

The message management table m_K at time 2 is the same as in FIG. 16. With regard to the message management table m_A at time 2, the node A registers the message XID=“101” in the message management table m_A as the first entry. More specifically, the node A makes setting such that ENT(1). activation=“valid”, ENT(1). XID=“101”, ENT(1). response state=“waiting”, ENT(1). total step number=“0”, ENT(1). execution step number=“0”, and ENT(1). execution step state=“waiting”. In addition, at time 2, the node A starts a process for the command RPC_b.

Here, the node A performs the process for the command RPC_a and the process for the command RPC_b. With regard to resource competition between the process for the command RPC_a and the process for the command RPC_b, the node A avoids the resource completion using an exclusive control mechanism which is included in the OS of the node A. More specifically, the node A performs control such that resource is updated by performing the process for the command RPC_a which is received in advance before the resource is referred to by performing the process for the command RPC_b using the exclusive control mechanism.

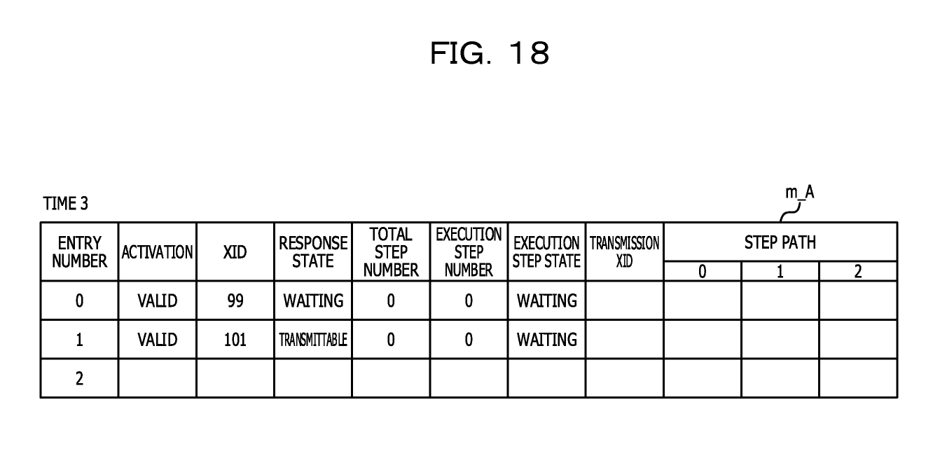

FIG. 18 illustrates a state at time 3 after the execution of the commands starts in the two-stage hierarchy. FIG. 18 illustrates a state in which the node A completes the process for the command RPC_b at time 3 which elapses from time 2 by 1 time unit.

The message management table m_K at time 3 is the same as in FIG. 16. With regard to the message management table m_A at time 3, the node A makes setting such that ENT(1). response state=“transmittable” if the process for the command RPC_b is completed, and determines whether or not to transmit a response to the message XID=“101”. In this case, the node A determines not to transmit a response to the message XID=“101” because ENT(0). response state corresponding to the message XID=“99” which is prior to the message XID=“101” is “waiting”.

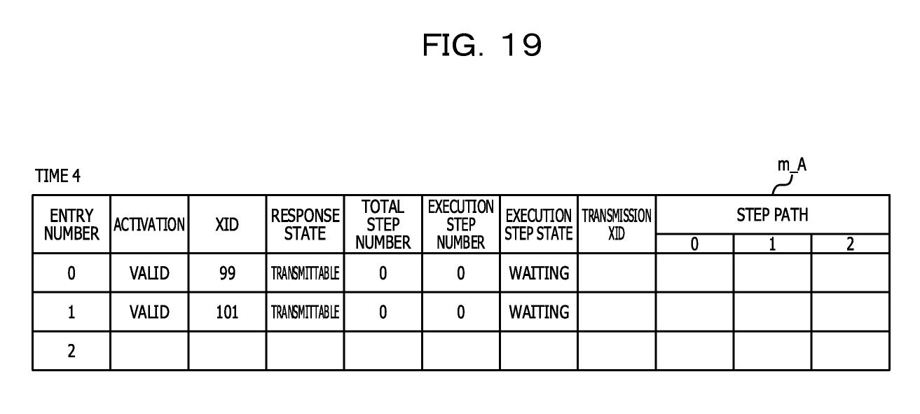

FIG. 19 illustrates a state at time 4 after the execution of the commands starts in the two-stage hierarchy. FIG. 19 illustrates a state in which the node A completes the process for the command RPC_a at time 4 which elapses from time 3 by 1 time unit.

The message management table m_K at time 4 is the same as in FIG. 16. With regard to the message management table m_A at time 4, when the process for the command RPC_a is completed, the node A makes setting such that ENT(0). response state=“transmittable”.

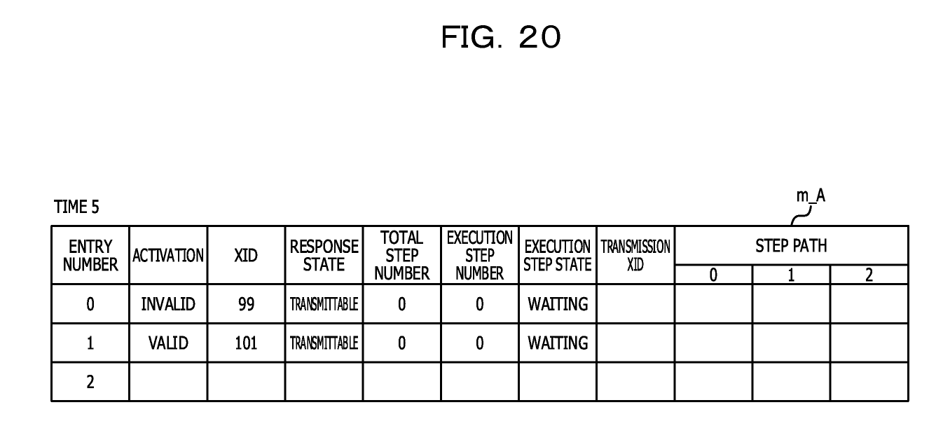

FIG. 20 illustrates a state at time 5 after the execution of the commands starts in the two-stage hierarchy. FIG. 20 illustrates a state at time 5 immediately after the node A makes setting such that ENT(0). response state=“transmittable” from time 4.

The message management table m_K at time 5 is the same as in FIG. 16. With regard to the message management table m_A at time 5, the node A transmits a response to the message XID=“99” to the client K. Further, the node A makes setting such that ENT(0). activation=“invalid”.

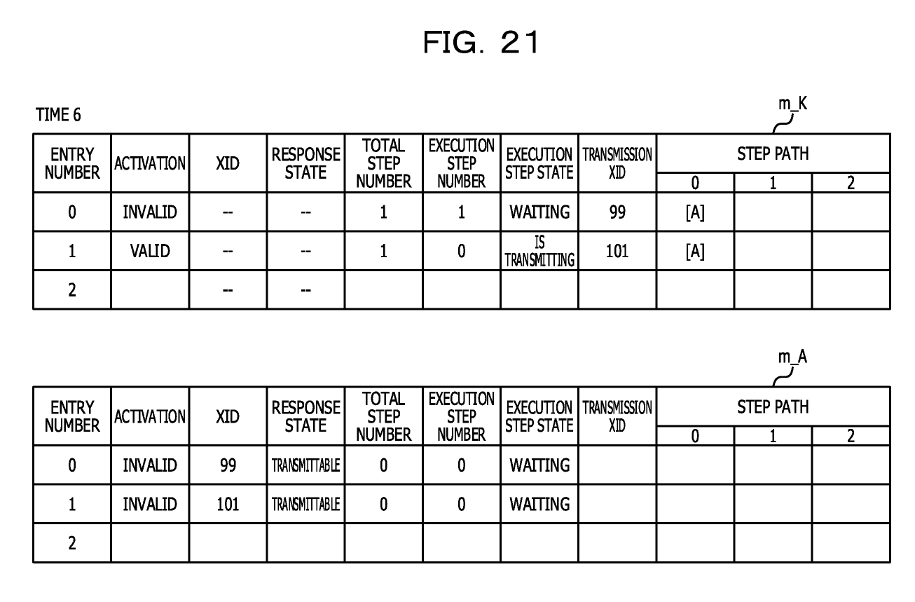

FIG. 21 illustrates a state of time 6 after the execution of the commands starts in the two-stage hierarchy. FIG. 21 illustrates a state in which the client K receives the response to the message XID=“99” at time 6 which elapses from time 5 by 1 time unit.

With regard to the message management table m_K at time 6, if the response to the message XID=“99” is received, the client K makes setting such that ENT(0). execution step state=“waiting”, ENT(0). execution step number=“1”, and ENT(0). activation=“invalid”.

In addition, with regard to the message management table m_A at time 6, the node A transmits the response to the message XID=“101” to the client K. Further, the node A makes setting such that ENT(1). activation=“invalid”. Here, the node A may transmit the response to the message XID=“101” immediately after the response to the message XID=“99” is transmitted to the client K.

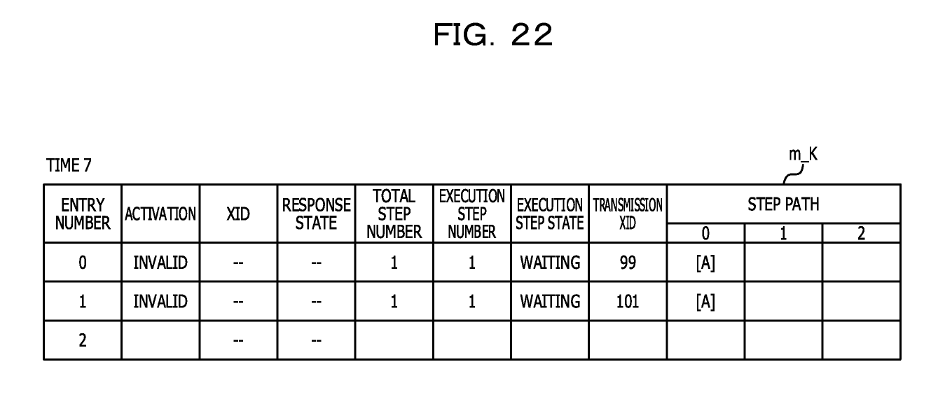

FIG. 22 illustrates a state of time 7 after the execution of the commands starts in the two-stage hierarchy. FIG. 22 illustrates a state in which the client K receives the response to the message XID=“101” at time 7 which elapses from time 6 by 1 time unit.

The message management table m_A at time 7 is the same as in FIG. 21. With regard to the message management table m_K at time 7, when the response to the message XID=“101” is received, the client K makes setting such that ENT(1). execution step state=“waiting”, ENT(1). execution step number=“1”, and ENT(1). activation=“invalid”.

Example of Three-Stage Hierarchy

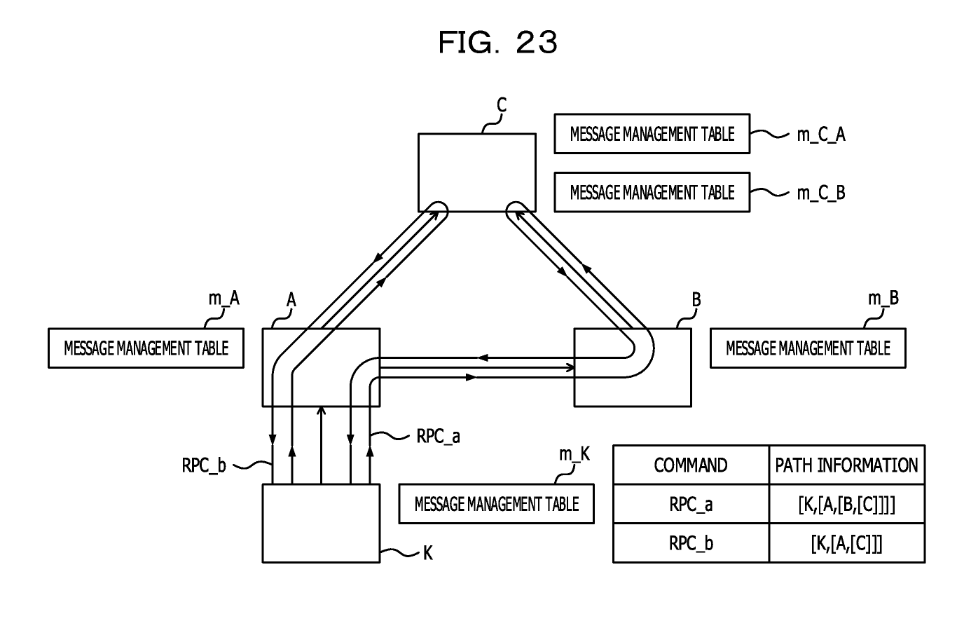

FIG. 23 illustrates an example of the relationship between a client and a server in a three-stage hierarchy. FIGS. 23 to 45 illustrate an example, in which the node A, which is a server, receives a command RPC_a and a command RPC_b from the client K, which is a client, and the nodes A, B, and C execute each of the commands, as a second example. The node A receives the command RPC_b after receiving the command RPC_a. In FIGS. 23 to 45, the path information of the command RPC_a is [K,[A,[B,[C]]]]. In addition, in FIGS. 23 to 45, the path information of the command RPC_b is [K,[A,[C]]].

In the example of FIGS. 23 to 45, RPC transmission time between the nodes is set to 1 unit time as the time taken for processing a process. In addition, time, which is taken from when the node A starts the process for the command RPC_a to when an RPC call is generated for the node B, is set to two unit times. In addition, time, which is taken from when the node A starts the process for the command RPC_b to when an RPC call is generated for the node C, is set to 1 unit time. In addition, time, which is taken when the node B completes the process for the command RPC_a, is set to 0 unit time. In addition, time, which is taken when the node C completes the process for the command RPC_a, is set to 0 unit time, and time, which is taken when the node C completes the process for the command RPC_b, is set to 1 unit time.

As illustrated in FIG. 23, the nodes A and B, which are servers, and the client K, which is a client, respectively include the message management table m_A, the message management table m_B, and the message management table m_K. In addition, since the message management tables m are present for the respective input sessions, the node C, which is the server, include an input session message management table m_C_A from the node A and an input session message management table m_C_B from the node B.

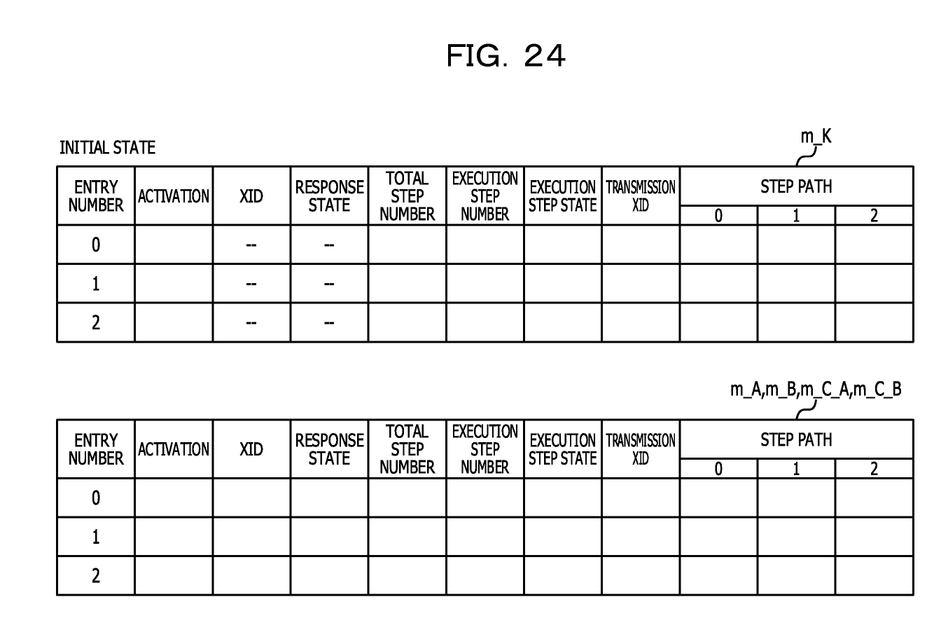

FIG. 24 illustrates an initial state before the commands are executed in three-stage hierarchy. FIG. 24 illustrates a state before the commands RPC_a and RPC_b are executed as an initial state. As illustrated in FIG. 24, the message management tables m_K, m_A, m_B, m_C_A, and m_C_B are empty.

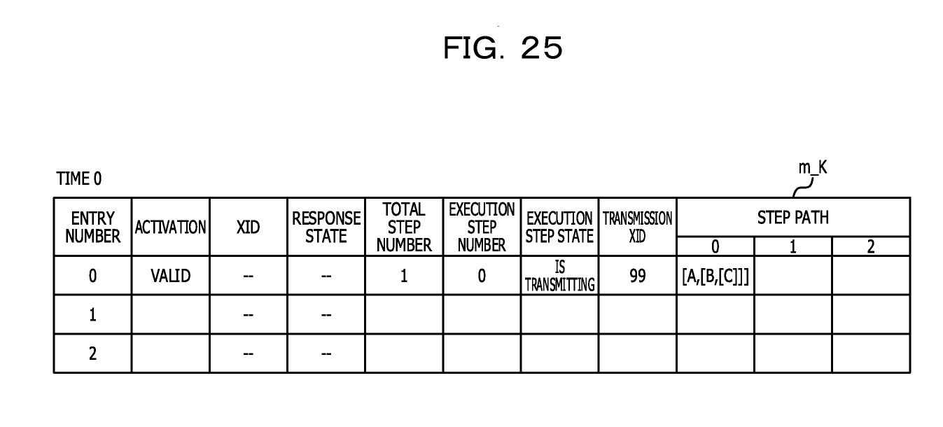

FIG. 25 illustrates a state of time 0 after the execution of the commands starts in the three-stage hierarchy. FIG. 25 illustrates a state in which the client K transmits the message XID=“99” to the node A as a processing request for the command RPC_a at time 0.

The message management tables m_A, m_B, m_C_A, and m_C_B at time 0 are the same as in FIG. 24. With regard to the message management table m_K at time 0, the client K registers the message XID=“99” in the message management table m_K as a 0-th entry. More specifically, the client K makes setting such that ENT(0). activation=“valid”, ENT(0). total step number=“1”, ENT(0). execution step number=“0”, ENT(0). execution step state=“is transmitting”, and ENT(0). transmission XID=“99”. In addition, the client K sets [A,[B,[C]]], which corresponds to the index 0 of the path information of the command RPC_a, to ENT(0). step path[0].

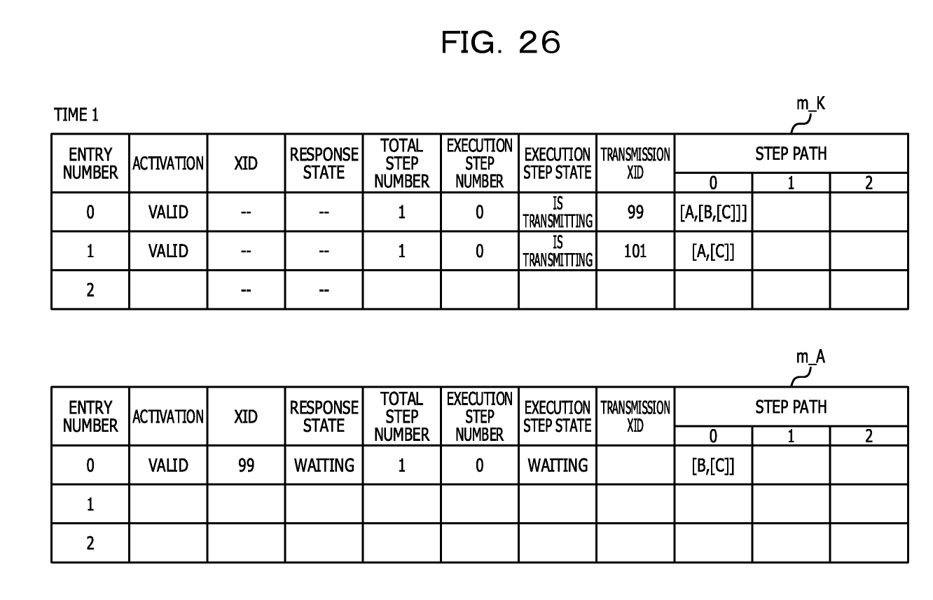

FIG. 26 illustrates a state of time 1 after the execution of the commands starts in the three-stage hierarchy. FIG. 26 illustrates a state in which the client K transmits the message XID=“101” to the node A and the node A receives the message XID=“99” as the execution of the command RPC_b at time 1 which elapses from time 0 by 1 unit time. Since the destinations of the message XID=“99” and the message XID=“101” are the same, the client K transmits the message XID=“101” in the same session as the session in which the message XID=“99” is transmitted.

The message management tables m_B, m_C_A, and m_C_B at time 1 are the same as in FIG. 24. With regard to message management table m_K at time 1, the client K registers the message XID=“101” in the message management table m_K as a first entry. More specifically, the client K makes setting such that ENT(1). activation=“valid”, ENT(1). total step number=“1”, ENT(1). execution step number=“0”, ENT(1). execution step state=“is transmitting”, and ENT(1). transmission XID=“101”. In addition, the client K sets [A,[C]], which corresponds to the index 0 of the path information of the message XID=“101”, to in ENT(1). step path[0].

In addition, with regard to the message management table m_A at time 1, the node A registers the message XID=“99” in the message management table m_A as a 0-th entry. More specifically, the node A makes setting such that ENT(0). activation=“valid”, ENT(0). XID=“99”, ENT(0). response state=“waiting”, ENT(0). total step number=“1”, ENT(0). execution step number=“0”, and ENT(0). execution step state=“waiting”. In addition, the node A sets [B,[C]], which corresponds to the index 0 of the path information of a message XID=“99”, to ENT(0). step path[0]. In addition, the node A starts the process for the command RPC_a at time 1.

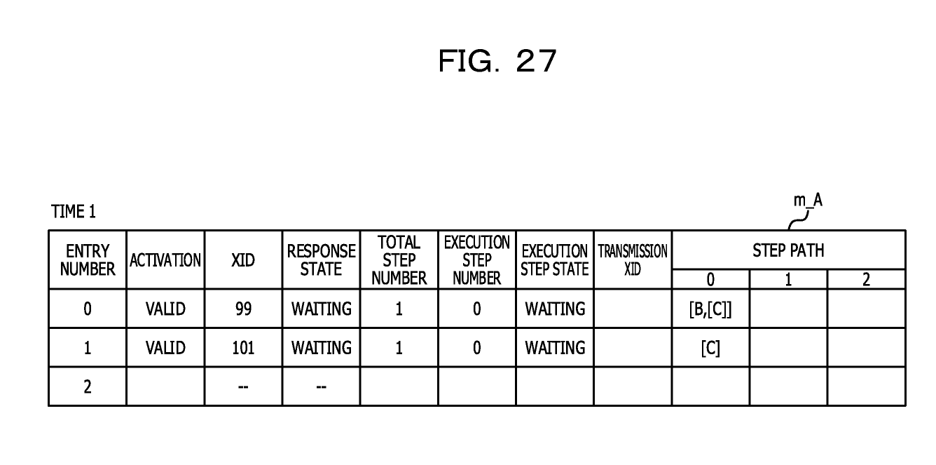

FIG. 27 illustrates a state of time 2 after the execution of the commands starts in the three-stage hierarchy. FIG. 27 illustrates a state in which the node A receives the message XID=“101” at time 2 which elapses from time 1 by 1 unit time.

The message management table m_K at time 2 is the same as in FIG. 26. In addition, the message management tables m_B, m_C_A, and m_C_B at time 2 are the same as in FIG. 24.

With regard to the message management table m_A at time 2, the node A registers the message XID=“101” in the message management table m_A as the first entry. More specifically, the node A makes setting such that ENT(1). activation=“valid”, ENT(1). XID=“101”, ENT(1). response state=“waiting”, ENT(1). total step number=“1”, ENT(1). execution step number=“0”, and ENT(1). execution step state=“waiting”. In addition, the node A sets [C], which corresponds to the index 0 of the path information of the message XID=“101”, to ENT(1). step path[0]. In addition, at time 2, the node A starts the process for the command RPC_b. Here, the node A performs the process for the command RPC_a and the process for the command RPC_b. Since the avoidance of resource competition is the same as in FIG. 17, the description thereof will not be repeated.

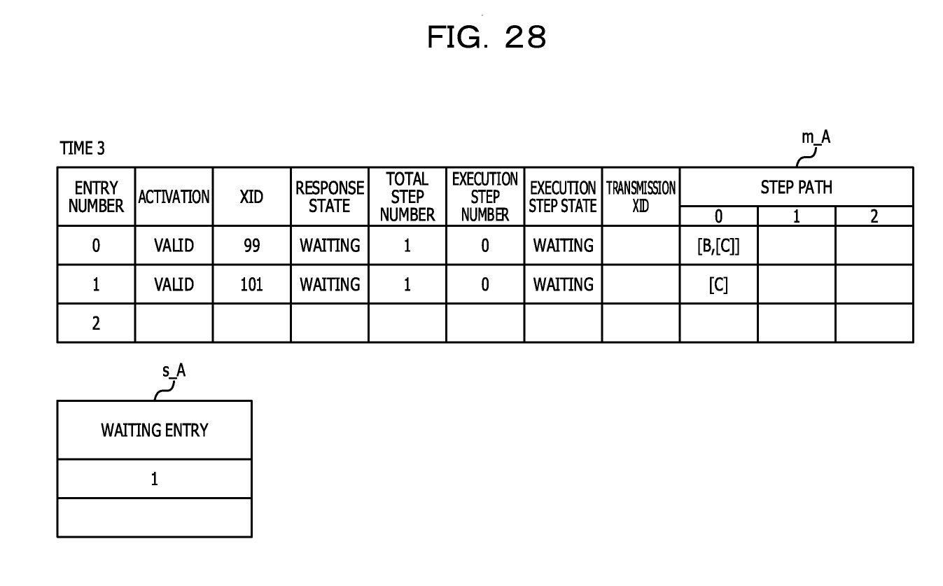

FIG. 28 illustrates a state at time 3 after the execution of the commands starts in the three-stage hierarchy. FIG. 28 illustrates a state in which an RPC call is generated for the node C while the node A is executing the process for the command RPC_b at time 3 which elapses from time 2 by 1 unit time.

The message management table m_K at time 3 is the same as in FIG. 26. In addition, the message management tables m_B, m_C_A, and m_C_B at time 3 are the same as in FIG. 24.

With regard to the message management table m_A at time 3, when the RPC call is generated for the node C, the node A determines whether or not to transmit a message to the step path[0] of the message XID=“101”. First, the node A acquires the step path[0]=[C] of the message XID=“101”. Subsequently, the node A acquires step paths[0]=[B,[C]], in which a response is not received, from among step paths of the message XID=“99” which is received prior to the message XID=“101”. Further, the node A determines whether or not the same node is included in the acquired two step paths. In the example of FIG. 28, the node C is included in the two step paths, and thus node A determines not to transmit a message to the step path[0] of the message XID=“101”. Accordingly, the node A causes the transmission of a message to the step path[0] of the message XID=“101” to be pending.

With regard to a message for the step path[0] of the message XID=“101” which is pending, the node A registers “1”, which is an entry number corresponding to the message XID=“101” that is pending, in the transmission waiting table s_A.

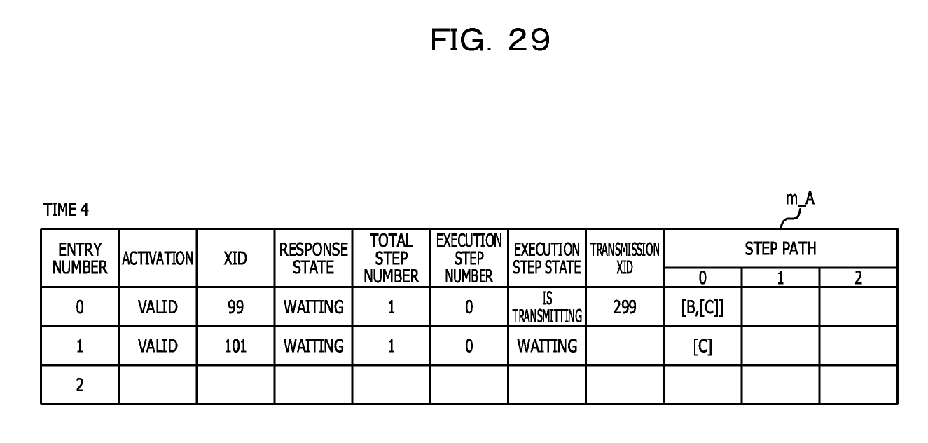

FIG. 29 illustrates a state at time 4 after the execution of the commands starts in the three-stage hierarchy. FIG. 29 illustrates a state in which an RPC call is generated for the node B while the node A is executing the process for the command RPC_a at time 4 which elapses from time 3 by 1 unit time.

The message management table m_K at time 4 is the same as in FIG. 26. In addition, the message management tables m_B, m_C_A, and m_C_B at time 4 are the same as in FIG. 24.

With regard to the message management table m_A at time 4, when an RPC call is generated for the node B, the node A determines whether or not to transmit a message to the step path[0] of the message XID=“99”. In this case, there is no message which is prior to the message XID=“99”, and thus the node A transmits a message to the step path[0] of the message XID=“99”. More specifically, the node A transmits a message XID=“299” to the node B as a message for the step path[0] of the message XID=“99”, and makes setting such that ENT(0). transmission XID=“299” and ENT(0). execution step state=“is transmitting”.

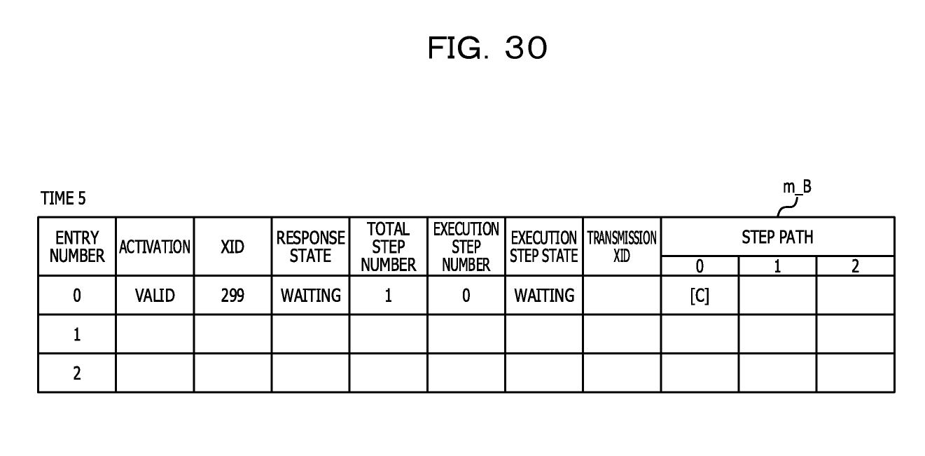

FIG. 30 illustrates a state at time 5 after the execution of the commands starts in the three-stage hierarchy. FIG. 30 illustrates a state in which the node B receives message XID=“299” at time 5 which elapses from time 4 by 1 unit time.

The message management table m_K at time 5 is the same as in FIG. 26. In addition, the message management table m_A at time 5 is the same as in FIG. 29. In addition, the message management tables m_C_A and m_C_B at time 5 are the same as in FIG. 24.

With regard to the message management table m_B at time 5, the node B registers the message XID=“299” in the message management table m_B as 0-th entry. More specifically, the node B makes setting such that ENT(0). activation=“valid”, ENT(0). XID=“299”, ENT(0). response state=“waiting”, ENT(0). total step number=“1”, ENT(0). execution step number=“0”, and ENT(0). execution step state=“waiting”. In addition, the node B sets [C], which corresponds to the index 0 of the path information of the message XID=“299”, to ENT(0). step path[0].

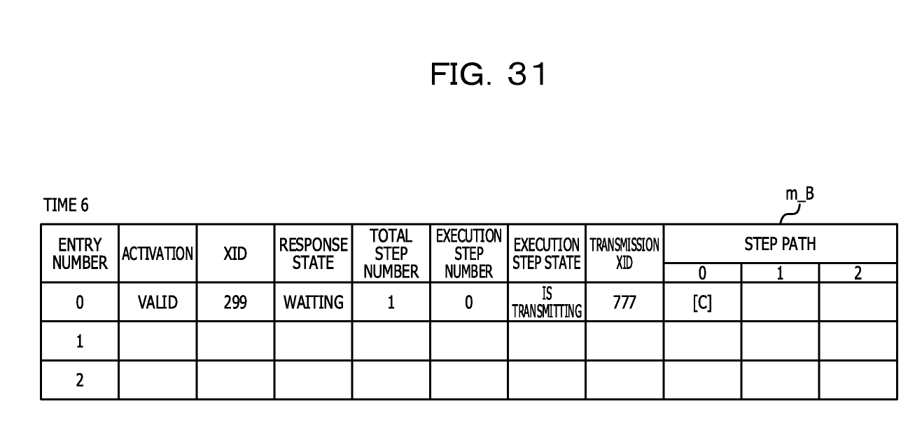

FIG. 31 illustrates the state at time 6 after the execution of the commands starts in the three-stage hierarchy. FIG. 31 illustrates a state of time 6 immediately after the node B makes setting such that ENT(0). execution step state=“waiting” from time 5.

The message management table m_K at time 6 is the same as in FIG. 26. In addition, the message management table m_A at time 6 is the same as in FIG. 29. In addition, the message management tables m_C_A and m_C_B at time 6 are the same as in FIG. 24.

With regard to the message management table m_B at time 6, the node B transmits a message to the step path[0] of the message XID=“299”. More specifically, the node A transmits a message XID=“777” to the node C as a message for the step path[0] of the message XID=“299”, and makes setting such that ENT(0). transmission XID=“777”.

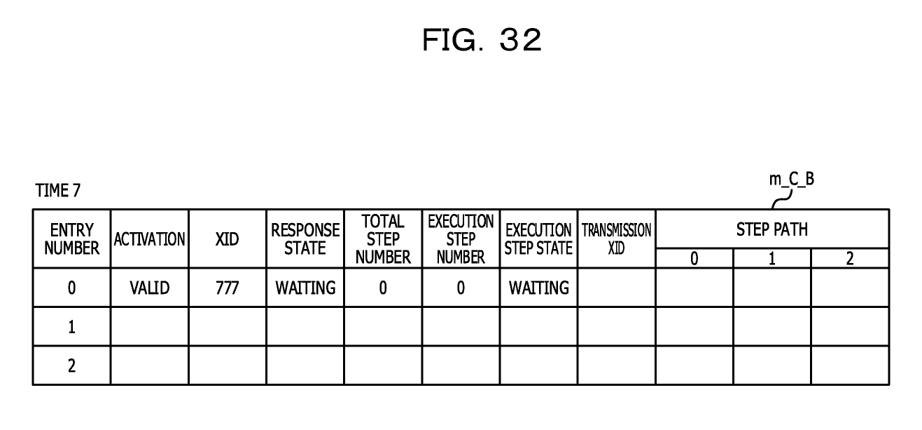

FIG. 32 illustrates a state at time 7 after the execution of the commands starts in the three-stage hierarchy. FIG. 32 illustrates a state in which the node B receives message XID=“7772” at time 7 which elapses from time 6 by 1 unit time.

The message management table m_K at time 7 is the same as in FIG. 26. In addition, the message management table m_A at time 7 is the same as in FIG. 29. In addition, the message management table m_B at time 7 is the same as in FIG. 31. In addition, the message management table m_C_A at time 7 is the same as in FIG. 24.

With regard to the message management table m_C_B at time 7, the node C registers the message XID=“777” in the message management table m_C_B as 0-th entry. More specifically, the node C makes setting such that ENT(0). activation=“valid”, ENT(0). XID=“777”, ENT(0). response state=“waiting”, ENT(0). total step number=“0”, ENT(0). execution step number=“0”, and ENT(0). execution step state=“waiting”. In addition, the node C starts the process of RPC_a.

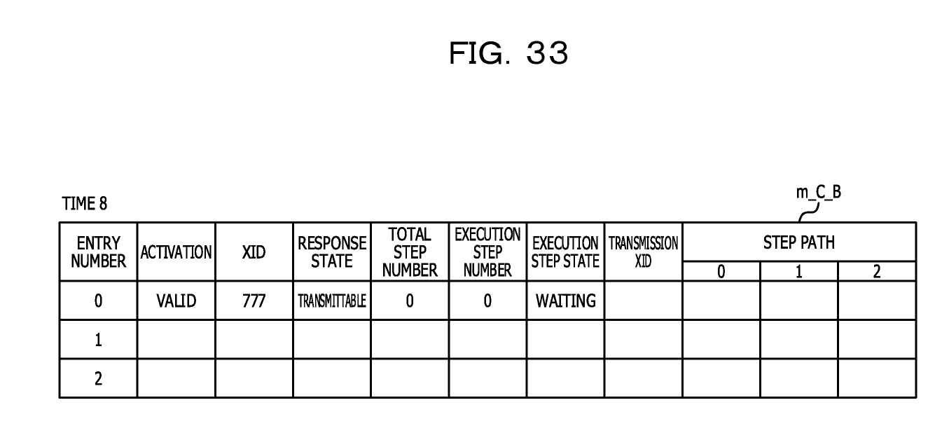

FIG. 33 illustrates a state at time 8 after the execution of the commands starts in the three-stage hierarchy. FIG. 33 illustrates a state of time 8, in which the node C makes setting such that ENT(0). execution step state=“waiting” and completes the process of RPC_a, from time 7.

The message management table m_K at time 8 is the same as in FIG. 26. In addition, the message management table m_A at time 8 is the same as in FIG. 29. In addition, the message management table m_B at time 8 as the same as in FIG. 31. In addition, the message management table m_C_A at time 8 is the same as in FIG. 24.

With regard to the message management table m_C_B at time 8, if the process for the command RPC_b is completed, the node C makes setting such that ENT(0). response state=“transmittable”, and determines whether or not to transmit the message a response to the XID=“777”. In this case, since there is no message prior to the message XID=“777”, the node C determines to transmit a response to the message XID=“777.

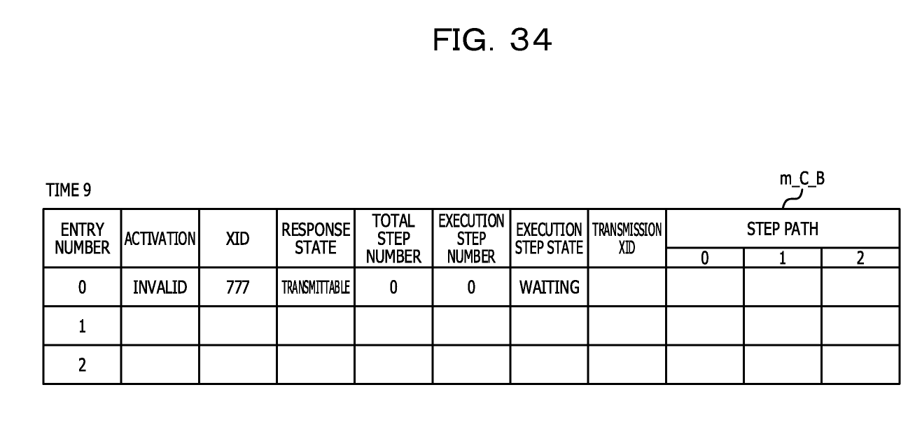

FIG. 34 illustrates a state at time 9 after the execution of the commands starts in the three-stage hierarchy. FIG. 33 illustrates a state at time 9, in which the node C determines to transmit a response to the message XID=“777”, from time 8.

The message management table m_K at time 9 is the same as in FIG. 26. In addition, the message management table m_A at time 9 is the same as in FIG. 29. In addition, the message management table m_B at time 9 is the same as in FIG. 31. In addition, the message management table m_C_A at time 9 is the same as in FIG. 24.

With regard to the message management table m_C_B at time 9, the node C transmits a response to the message XID=“777” to the node B transmit, and makes setting such that ENT(0). activation=“invalid”.

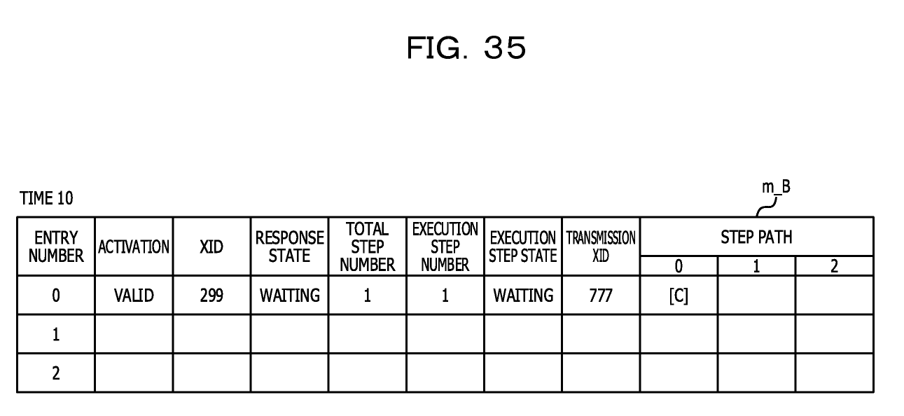

FIG. 35 illustrates a state at time 10 after the execution of the commands starts in the three-stage hierarchy. FIG. 35 illustrates a state at time 10, in which the node B receives the response from the node C, at time 10 which elapsed from time 9 by 1 unit time.

The message management table m_K at time 10 is the same as in FIG. 26. In addition, the message management table m_A at time 10 is the same as in FIG. 29. In addition, the message management table m_C_A at time 10 is the same as in FIG. 24. In addition, the message management table m_C_B at time 10 is the same as in FIG. 34. At time subsequent to time 10, the content of the message management table m_C_B is not changed, and thus the entry of the message management table m_C_B at time subsequent to time 10 will be omitted.

With regard to the message management table m_B at time 10, the node B specifies that the response, which is received from the node C, is a response to the message of ENT(0). XID=“777” with reference to the transmission XID of the message management table m_B. Further, the node B makes setting such that ENT(0). execution step number=“1”. Subsequently, the node B executes a process for RPC_b.

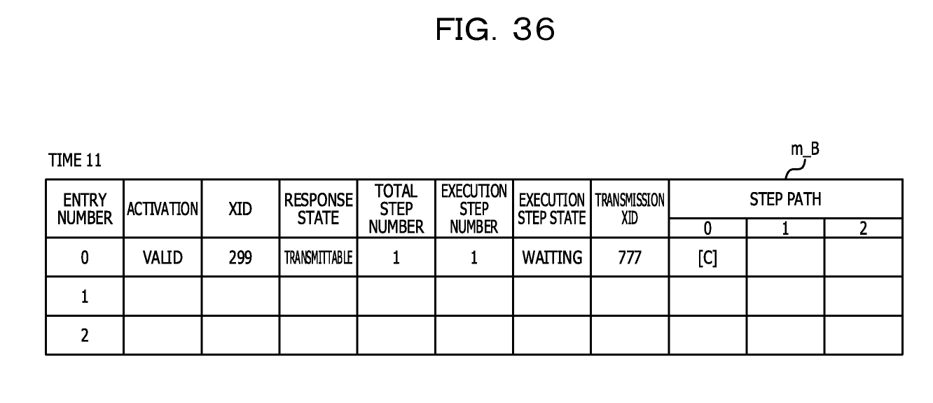

FIG. 36 illustrates a state at time 11 after the execution of the commands starts in the three-stage hierarchy. FIG. 36 illustrates a state at time 11, in which the node B completes the process for the command RPC_a, from time 10.

The message management table m_K at time 11 is the same as in FIG. 26. In addition, the message management table m_A at time 11 is the same as in FIG. 29. In addition, the message management table m_C_A at time 11 is the same as in FIG. 24.

With regard to the message management table m_B at time 11, if the process for the command RPC_a is completed, the node B makes setting such that ENT(0). response state=“transmittable”.

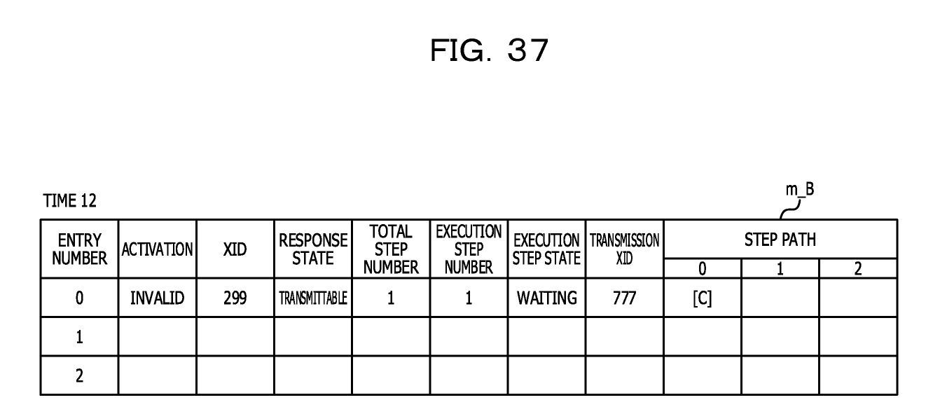

FIG. 37 illustrates a state at time 12 after the execution of the commands starts in the three-stage hierarchy. FIG. 37 illustrates a state at time 12, immediately after the node B makes setting such that ENT(0). response state=“transmittable”, from time 11.

The message management table m_K at time 12 is the same as in FIG. 26. In addition, the message management table m_A at time 12 is the same as in FIG. 29. In addition, the message management table m_C_A at time 12 is the same as in FIG. 24.

With regard to the message management table m_B at time 12, the node B transmits a response to the message XID=“299” to the node A. Further, the node B makes setting such that ENT(0). activation=“invalid”.

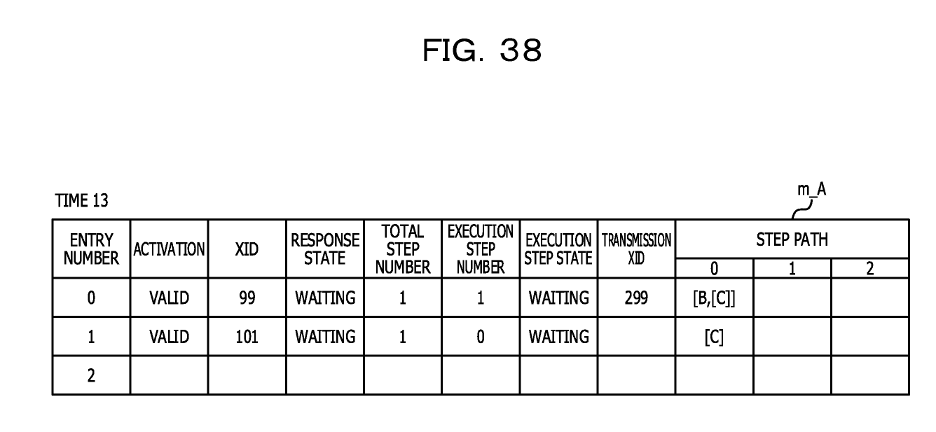

FIG. 38 illustrates a state at time 13 after the execution of the commands starts in the three-stage hierarchy. FIG. 38 illustrates a state in which the node A receives the response from the node B at time 13 which elapsed from time 12 by 1 unit time.

The message management table m_K at time 13 is the same as in FIG. 26. In addition, the message management table m_C_A at time 13 is the same as in FIG. 24. In addition, the message management table m_B at time 13 is the same as in FIG. 37. Since the content of the message management table m_B is not changed at time subsequent to time 13, and thus the entry of the message management table m_B at time subsequent to time 13 will be omitted.

With regard to the message management table m_A at time 13, the node A specifies that the response received from the node B is a response to the message of ENT(0). XID=“299” with reference to the transmission XID of the message management table m_A. Further, the node A makes setting such that ENT(0). execution step number=“1” and ENT(0). execution step state=“waiting”.

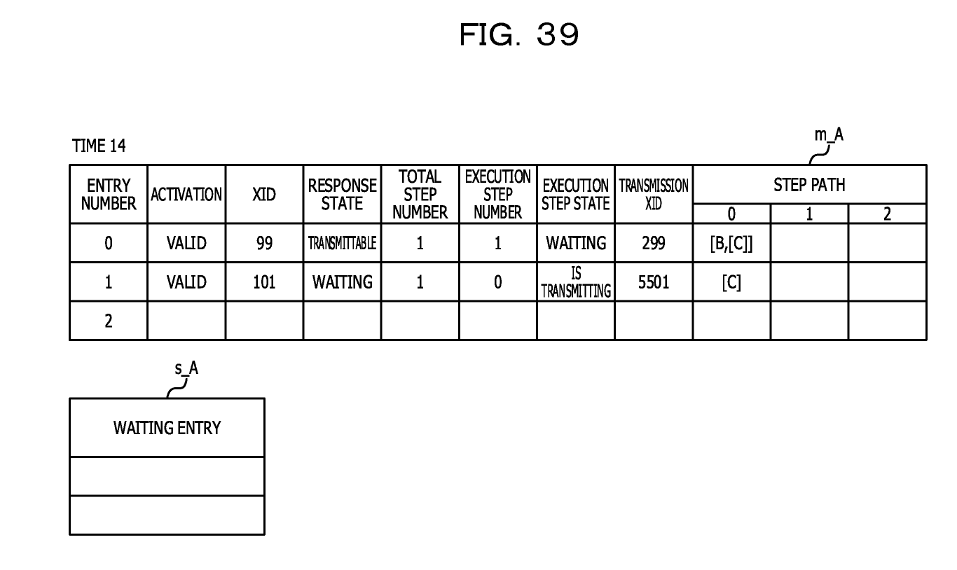

FIG. 39 illustrates a state at time 14 after the execution of the commands starts in the three-stage hierarchy. FIG. 39 illustrates a state at time 14, immediately after the node A makes setting such that ENT(0). execution step number=“1”, from time 13.

The message management table m_K at time 14 is the same as in FIG. 26. In addition, the message management table m_C_A at time 14 is the same as in FIG. 24.

With regard to message management table m_A at time 14, the node A determines whether or not there is a transmittable message when a response is received. More specifically, the node A determines whether or not there is a transmission pending message with reference to the transmission waiting table s_A. As illustrated in FIG. 28, the first entry is registered in transmission waiting table s_A. Accordingly, the node A determines whether or not it is possible to transmit a message for the first entry.

First, the node A acquires the step path[0]=[C] of the message XID=“101” as the first entry. Subsequently, the node A determines whether or not there is a step path, in which a response is not received, from among step paths of the message XID=“99” which is received prior to the message XID=“101”. In the example of FIG. 39, there is no step path, in which a response is not received, and a step path of an empty set is acquired. Further, the node A determines whether or not the same node is included in the acquired two step paths. In the example of FIG. 39, there is no node which is included in two step paths, and thus the node A determines to transmit a message to the step path[0] of the message XID=“101”.

Further, the node A transmits a message XID=“5501” to the node C as a message for the step path[0] of the message XID=“101”, and makes setting such that ENT(1). transmission XID=“5501” and ENT(1). execution step state=“is transmitting”.

In addition, the node A completes the process for RPC_a in at time 14. Further, when the process for RPC_a is completed, the node A makes setting such that ENT(0). response state=“transmittable”.

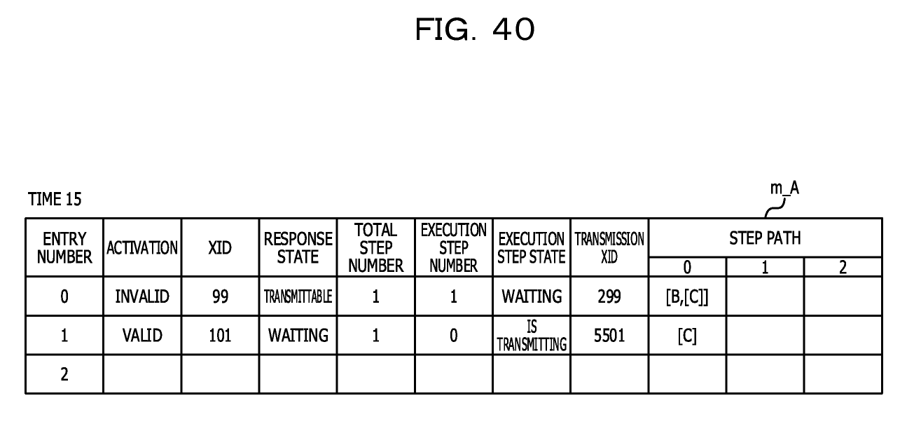

FIG. 40 illustrates a state at time 15 after the execution of the commands starts in the three-stage hierarchy. FIG. 40 illustrates a state at time 15 which is immediately after the node A completes the process for RPC_a from time 14.

The message management table m_K at time 15 is the same as in FIG. 26. In addition, the message management table m_C_A at time 15 is the same as in FIG. 24.

With regard to the message management table m_A at time 15, the node A transmits the response to the message XID=“99” to the client K. Further, the node A makes setting such that ENT(0). activation=“invalid”.

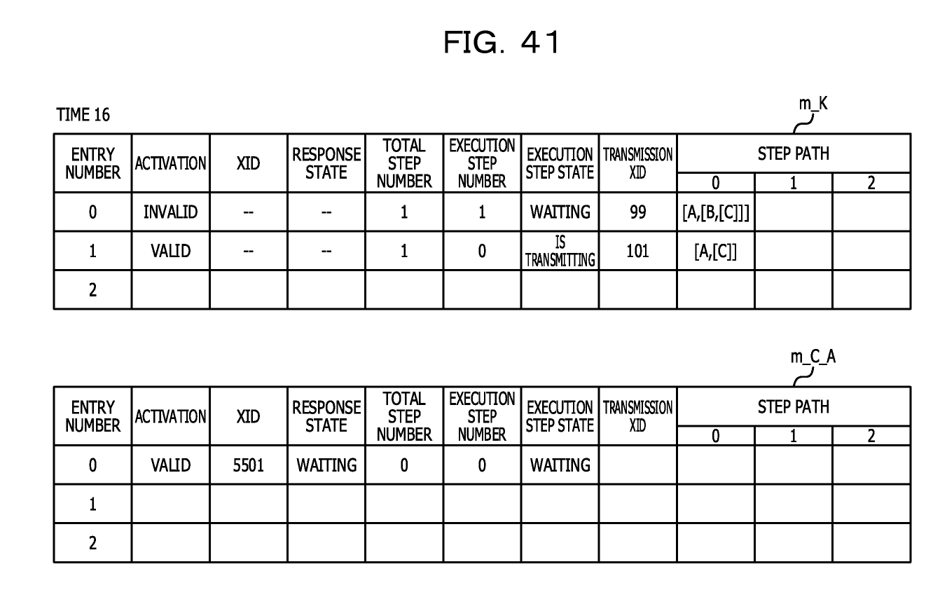

FIG. 41 illustrates a state at time 16 after the execution of the commands starts in the three-stage hierarchy. FIG. 41 illustrates a state in which the client K receives the response from the node A at time 16, which elapsed from time 15 by 1 unit time, and the node C receives the message XID=“5501”.

The message management table m_A at time 16 is the same as in FIG. 40. With regard to the message management table m_K at time 16, the client K specifies that the response, which is received from the node C, is a response to a message of the 0-th entry with reference to the transmission XID of the message management table m_K. Further, the client K makes setting such that ENT(0). activation=“invalid”.

In addition, with regard to the message management table m_C_A at time 16, the node C registers the message XID=“5501” in the message management table m_C_A as the 0-th entry. The node C makes setting such that ENT(0). activation=“valid”, ENT(0). XID=“5501”, ENT(0). response state=“waiting”, ENT(0). total step number=“0”, ENT(0). execution step number=“0”, and ENT(0). execution step state=“waiting”.

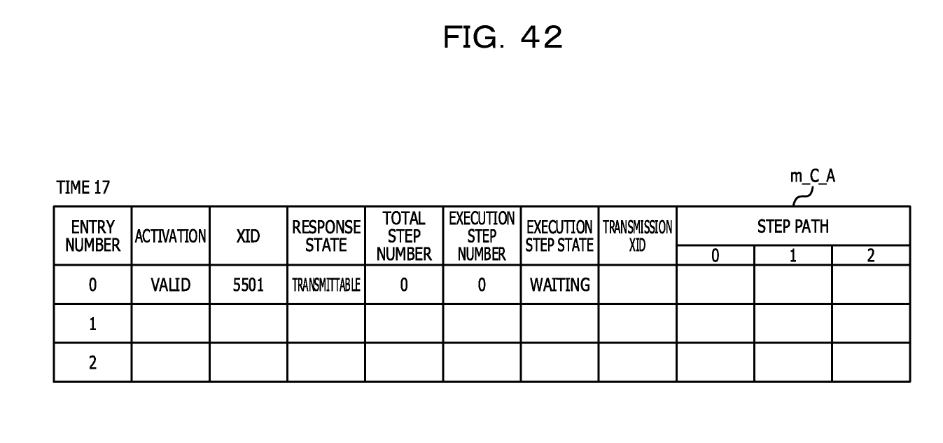

FIG. 42 illustrates a state at time 17 after the execution of the commands starts in the three-stage hierarchy. FIG. 42 illustrates a state at time 17, in which the node C completes the process for the command RPC_b, from time 16.

The message management table m_K at time 17 is the same as in FIG. 41. The message management table m_A at time 17 is the same as in FIG. 40. With regard to the message management table m_C_A at time 17, if the process for the command RPC_b is completed, the node C makes setting such that ENT(0). response state=“transmittable”.

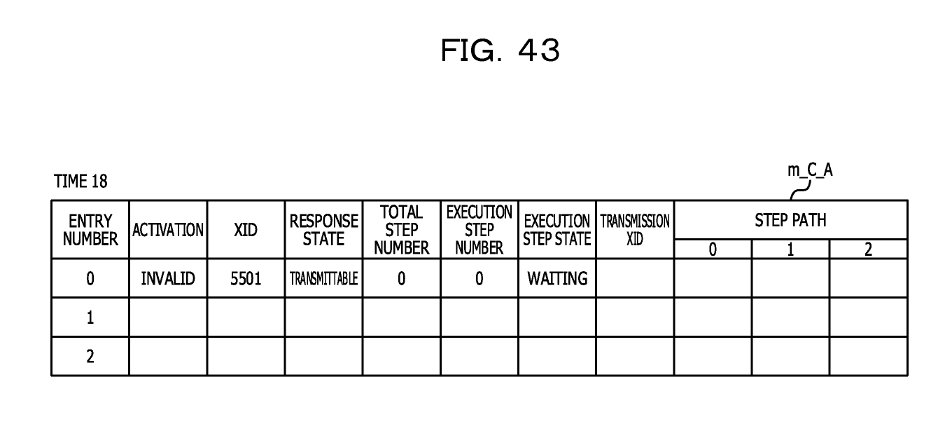

FIG. 43 illustrates a state at time 18 after the execution of the commands starts in the three-stage hierarchy. FIG. 43 illustrates a state at time 18, immediately after the node C makes setting such that ENT(0). response state=“transmittable”, from time 17.

The message management table m_K at time 18 is the same as in FIG. 41. The message management table m_A at time 18 is the same as in FIG. 40. With regard to the message management table m_C_A at time 18, the node C transmits a response to the message XID=“5501” to the node A. Further, the node A makes setting such that ENT(0). activation=“invalid”.

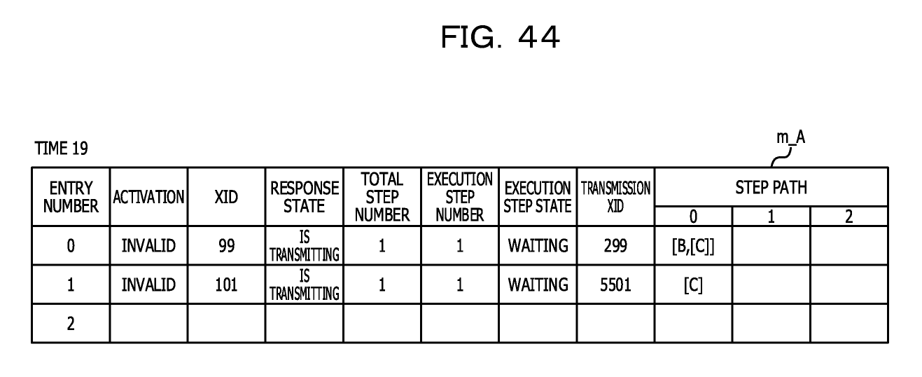

FIG. 44 illustrates a state at time 19 after the execution of the commands starts in the three-stage hierarchy. FIG. 44 illustrates a state in which the node A receives a response to the message XID=“5501” at time 19 which elapsed from time 18 by 1 unit time.

The message management table m_K at time 19 is the same as in FIG. 41. The message management table m_C_A at time 19 is the same as in FIG. 43. Since the content of the message management table m_C_A is not changed at time subsequent to time 19, and thus the entry of the message management table m_C_A at time subsequent to time 19 will be omitted.

With regard to the message management table m_A at time 19, the node A specifies that the response, which is received from the node C, is a response to a message of ENT(1). XID=“5501” with reference to the transmission XID of the message management table m_A. Further, the node A makes setting such that ENT(1). execution step number=“1” and ENT(1). execution step state=“waiting”. Further, when the process for the command RPC_b is completed, the node A makes setting such that ENT(1). response state=“transmittable”.

Further, the node A transmits the response to the message XID=“101” to the client K. Further, the node A makes setting such that ENT(1). activation=“invalid”.

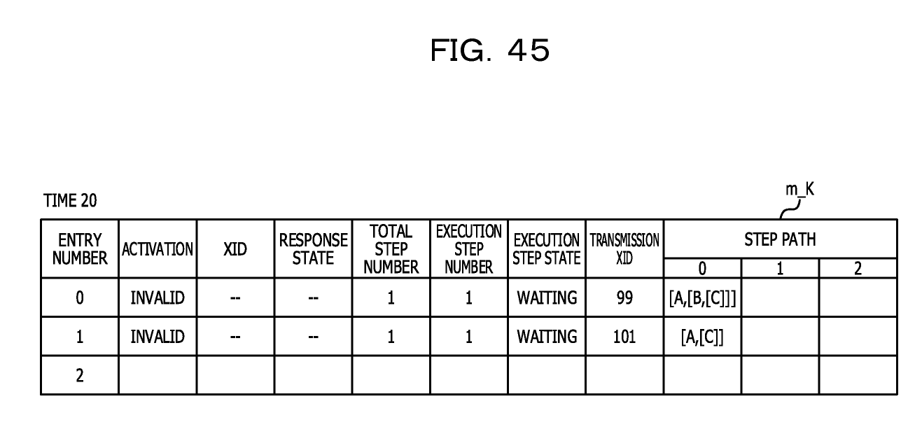

FIG. 45 illustrates a state at time 20 after the execution of the commands starts in the three-stage hierarchy. FIG. 45 illustrates a state in which the client K receives the response to the message XID=“101” at time 20 which elapsed from time 19 by 1 unit time.

The message management table m_A at time 20 is the same as in FIG. 44. With regard to the message management table m_K at time 20, the client K specifies that the response, which is received from the node A, is a response to a message of ENT(1). XID=“101” with reference to the transmission XID of the message management table m_A. Further, the client K makes setting such that ENT(1). execution step number=“1” and ENT(1). execution step state=“waiting”. Further, the client K makes setting such that ENT(1). activation=“invalid”.

FIG. 46 illustrates an example of the order of judgment targets in path information when a message is transmitted. FIG. 46 illustrates an example of the order of judgment targets in the step path of the message management table m when a node determines whether or not it is possible to transmit a message. The node sets the step path of a message prior to a transmission target message to a judgment target in order from the largest entry number. Further, the node sets the judgment target from a step corresponding to total step number-1 in the step path of the messages prior to the transmission target message.

FIG. 46 illustrates an example in a case in which the entry number of the transmission target message is “i”. First, the node sequentially sets a judgment target from a step of total step number-1 in the step paths having an entry number i-1. Here, a node group, which is included in the step path of the judgment target, corresponds to the first node group in FIG. 4. In addition, a node group, which is included in the step path of the transmission target message, corresponds to the second node group in FIG. 4. If the step path, which is determined to be the judgment target, does not interfere in the step path of the transmission target message at all, a step of total step number-2 is set to the judgment target. As above, the node decrements a step which is the judgment target.

In addition, there is a case in which the judgment target is a step corresponding to an execution step number. At this time, the node determines whether or not the step path which is determined to be the judgment target does not interfere in the step path of the transmission target message at all or a message is being transmitted to a node at the head of the set path of the transmission target message. If the step path which is determined to be the judgment target does not interfere in the step path of the transmission target message at all or a message is being transmitted to a node at the head of the set path of the transmission target message, the nodes decrements an entry to be the judgment target.

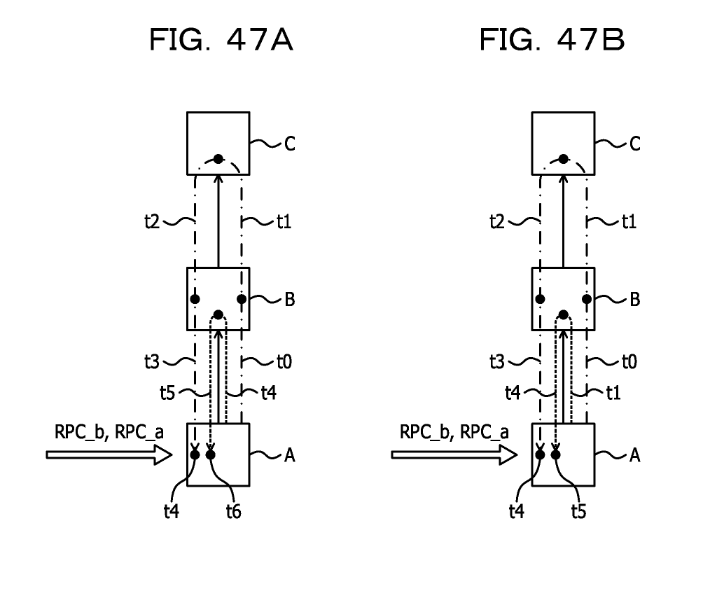

FIGS. 47A and 47B illustrate an example of comparison of time which is taken from the start to completion of command execution. FIG. 47A illustrate an example of time which is taken from the start to completion of command execution when synchronous execution is performed, and FIG. 47B illustrate an example of time which is taken from the start to completion of command execution when a distributed processing method according to the embodiment is performed. As common setting in FIGS. 47A and 47B, the nodes A, B, and C sequentially execute two commands RPC_a and RPC_b. In FIGS. 47A and 47B, a dashed-line arrow indicates RPC_a and a dotted-line arrow indicates RPC_b. In addition, black circles in FIGS. 47A and 47B indicate processes for RPCs in the respective nodes. Further, time, which is taken for transmitting a message and a response, is set to 1 unit time. In addition, process time in the node A is set to 1 unit time, and the process time in nodes B and C is set to 0 unit time.

In FIG. 47A, 6 unit time is taken from when RPC_a starts to when RPC_b ends. At time t0, the node A transmits a message of RPC_a to the node B. Subsequently, at time t1 after 1 unit time from time t0, the node B transmits the message of RPC_a to the node C. Further, at time t2 after 1 unit time from time t1, the node C transmits a response to RPC_a to the node B. Subsequently, at time t3 after 1 unit time from time t2, the node B transmits a response to RPC_a to the node A. Further, at time t4 after 1 unit time from time t3, the node A completes the process for RPC_a.

In addition, at time t4, the node A transmits a message of RPC_b to the node B. Subsequently, at time t5 after 1 unit time from time t4, the node B transmits a response to RPC_b to the node A. Further, at time t6 after 1 unit time from time t5, the node A completes the process for RPC_b.

In FIG. 47B, 5 unit time is taken from when RPC_a starts to when RPC_b ends. At time t0, the node A transmits a message of RPC_a to the node B. Subsequently, at time t1 after 1 unit time from time t0, the node B transmits the message of RPC_a to the node C. In addition, at time t1, the node A transmits a message of RPC_b to the node B. Further, at time t2 after 1 unit time from time t1, the node C transmits a response to RPC_a to the node B. In addition, at time t2, the node B does not transmit the response to RPC_a, and thus transmission of the response of RPC_b is pending. Subsequently, at time t3, the node B transmits the response to RPC_a to the node A. In addition, at time t3, the node B is transmitting the response to RPC_a and the transmission is not completed, and thus transmission of the response to RPC_b is pending.

Further, at time t4 after 1 unit time from time t3, the node A completes the process for RPC_a. In addition, at time t4, the node B transmits the response to RPC_b to the node A. Further, at time t5 after 1 unit time from time t4, the node A completes the process for RPC_b.

As above, in the distributed processing method according to the embodiment, it is possible to reduce the time, which is taken from the start to completion of the command execution, by 1 unit time compared to a method using synchronous execution. In addition, in the method using synchronous execution, a meeting point is the node A. In contrast, in the distributed processing method according to the embodiment, the meeting point is the node B.

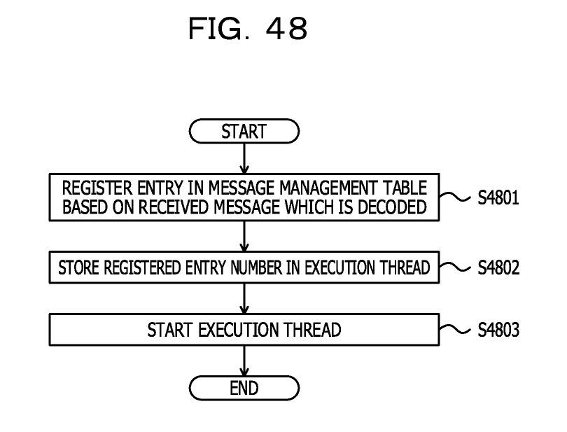

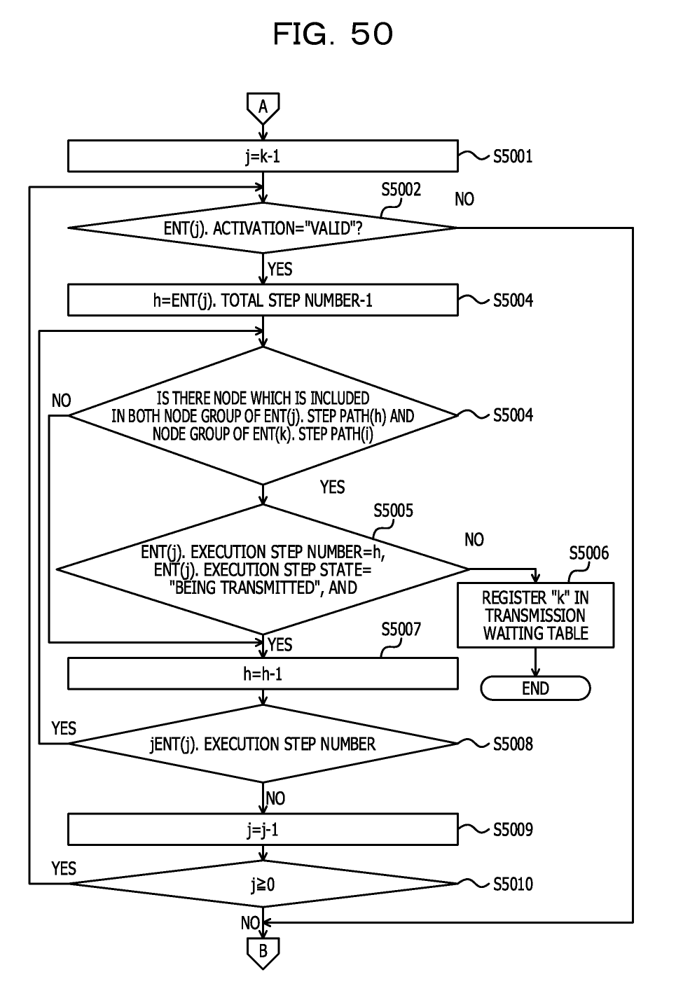

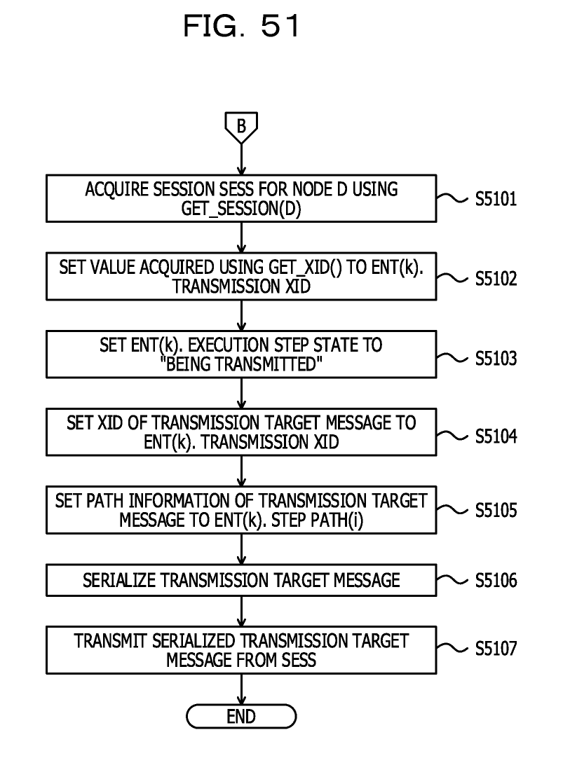

Subsequently, flowcharts of a message reception process, a message transmission process, a response transmission process, and a response reception process, which are executed by the nodes A, B, C, . . . , will be described with reference to FIGS. 48 to 53. Although each of the nodes performs the message reception process, the message transmission process, the response transmission process, and the response reception process, an example in which the node A executes the above-described processes will be described as an example. In addition, the client K performs the message transmission process and the response reception process. The message transmission process and the response reception process, which are performed by the client K, are the same as the message transmission process and the response reception process which are performed by each of the nodes.

FIG. 48 is a flowchart illustrating an example of the message reception process procedure. The message reception process is a process which is performed when a message is received. The node A registers an entry in the message management table m based on a received message which is decoded (step S4801). Subsequently, the node A stores a registered entry number in an execution thread (step S4802). Further, the node A starts the execution thread (step S4803). After the process in step S4803 ends, the node A ends the message reception process.

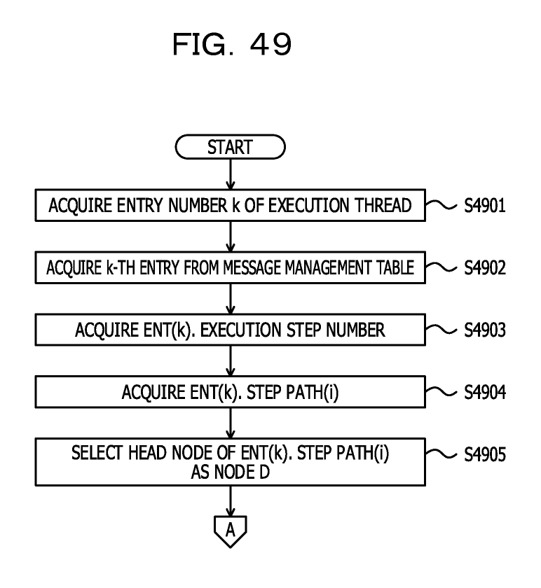

FIGS. 49, 50, and 51 are flowcharts illustrating an example of the message transmission process procedure. The message transmission process is a process which is performed when a message is transmitted.

The node A acquires the stored entry number k of the execution thread (step S4901). If an execution subject is the client K in step S4901, the client K registers the entry in the message management table m when a message is transmitted, and acquires the registered entry number k.

Subsequently, the node A acquires a k-th entry from the message management table m (step S4902). Further, the node A acquires ENT(k). execution step number (step S4903). Hereinafter, for simplification of description, it is assumed that ENT(k). execution step number=“i”. Subsequently, the node A acquires ENT(k). step path(i) (step S4904). Further, the node A selects a head node of ENT(k). step path(i) as a node D (step S4905).

Subsequently, the node A sets “j” to “k-1” (step S5001). Further, the node A determines whether or not ENT(j). activation is “valid” (step S5002). When ENT(j). activation is “valid” (step S5002: Yes), the node A sets “h” to “ENT(j). total step number-1” (step S5003). Subsequently, the node A determines whether or not there is a node which is included in both a node group of ENT(j). step path(h) and a node group of ENT(k). step path(i) (step S5004).

When there is a node which is included in both two node groups (step S5004: Yes), the node A continuously determines whether or not subsequent conditions are satisfied (step S5005). The conditions are that ENT(j). execution step number is “h”, ENT(j). execution step state is “being transmitted”, and the head node of ENT(j). step path(h) is the node D. When the above-described conditions are not satisfied (step S5005: No), the node A registers “k” in the transmission waiting table s (step S5006). After the process in step S5006 ends, the node A ends the message transmission process.

In contrast, when the above-described conditions are satisfied (step S5005: Yes) or there is no node which his included in both two node groups (step S5004: No), the node A decrements “h” (step S5007). Further, the node A determines whether or not “h” is equal to or greater than ENT(j). execution step number (step S5008). When “h” is equal to or greater than ENT(j). execution step number (step S5008: Yes), the node A proceeds to the process in step S5004.

In contrast, when “h” is less than ENT(j). execution step number (step S5008: No), the node A decrements “j” (step S5009). Further, the node A determines whether or not “j” is equal to or greater than “0” (step S5010). When “j” is equal to or greater than “0” (step S5010: Yes), the node A proceeds to the process in step S5002.

In contrast, when “j” is less than “0” (step S5010: No) or ENT(j). activation is not “valid” (step S5002: No), the node A acquires a session SESS for the node D using GET_SESSION(D) (step S5101). Here, a reason that confirming may not be performed from 0 to “j-1” when No in step S5002 is that activation with regard to 0 to “j-1” is also “invalid” when ENT(j). activation=“invalid” in a certain “j”. In addition, GET_SESSION( ) is a function to acquire a session. In addition, at a point at which the process in step S5101 is executed, a message, which precedes the transmission target message, is in a path which does not interfere at all or is being transmitted to the node D which is the same destination. At this time, the node A transmits a message without waiting for the response of the preceding message.

Subsequently, the node A sets a value acquired using GET_XID( ) to ENT(k). transmission XID (step S5102). GET_XID( ) is a function to acquire the XID of the message. Further, the node A sets ENT(k). execution step state to “being transmitted” (step S5103). Subsequently, the node A sets the XID of the transmission target message to ENT(k). transmission XID (step S5104). Subsequently, the node A sets the path information of the transmission target message to ENT(k). step path(i) (step S5105). Further, the node A serializes the transmission target message (step S5106). Subsequently, the node A transmits the serialized transmission target message from SESS (step S5107). After the process in step S5107 ends, the node A ends the message transmission process. After the process in step S5107 ends, the execution thread waits for the reception of a response.

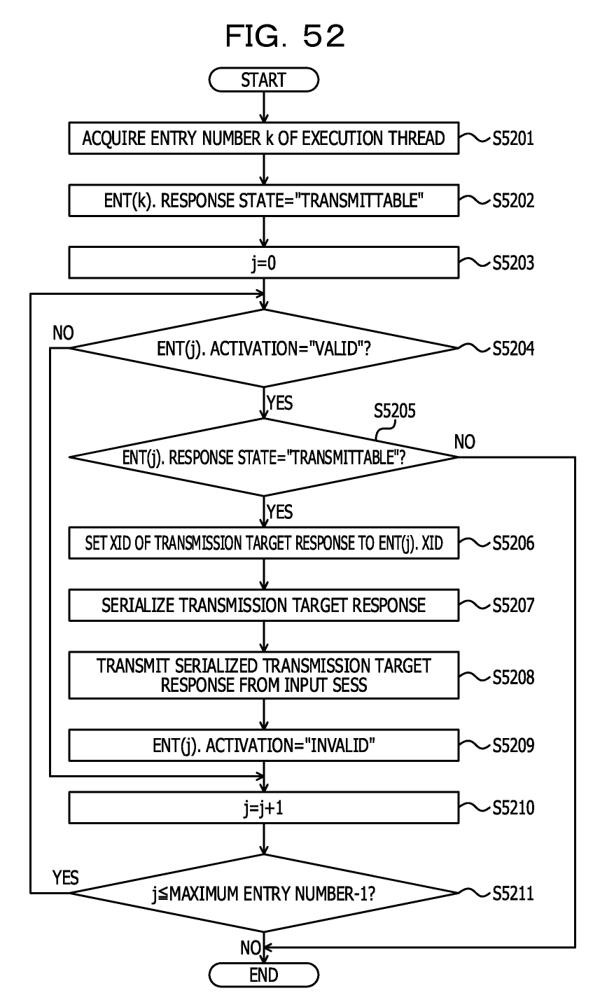

FIG. 52 is a flowchart illustrating an example of the response transmission process procedure. The response transmission process is a process which is performed when a response is transmitted. The response is transmitted at the end of the RPC process of the execution thread. In the response transmission process, the end of processing of an execution thread immediately before the a response transmission target thread is matched with and the end of response transmission due to the end of the immediately before execution thread.

The node A acquires the entry number k of the execution thread (step S5201). Subsequently, the node A sets ENT(k). response state to “transmittable” (step S5202). Further, the node A sets “j” to 0 (step S5203). Subsequently, the node A determines whether or not ENT(j). activation is “valid” (step S5204). When ENT(j). activation is “valid” (step S5204: Yes), the node A continuously determines whether or not ENT(j). response state is “transmittable” (step S5205). When ENT(j). response state is “transmittable” (step S5205: Yes), the node A sets the XID of the transmission target response to ENT(j). XID (step S5206). In addition, the node A sets a value for each of the fields of the transmission target response. More specifically, the node A stores a processing result of the execution thread in the unique response parameter of a node transmission target response.

Further, the node A serializes the transmission target response (step S5207). Subsequently, the node A transmits a serialized transmission target response from input SESS (step S5208). Further, the node A sets ENT(j). activation to “invalid” (step S5209).

After the process in step S5209 ends or when ENT(j). activation is “invalid” (step S5204: No), the node A increments “j” (step S5210). Further, the node A determines whether or not “j” is equal to or less than “the maximum number of entries-1” of the message management table m (step S5211). When “j” is equal to or less than “the maximum number of entries-1” of the message management table m (step S5211: Yes), the node A proceeds to the process in step S5204.

In contrast, when “j” is greater than “the maximum number of entries-1” of the message management table m (step S5211: No) or when ENT(j). response state is not “transmittable” (step S5205: No), the node A ends the response transmission process.

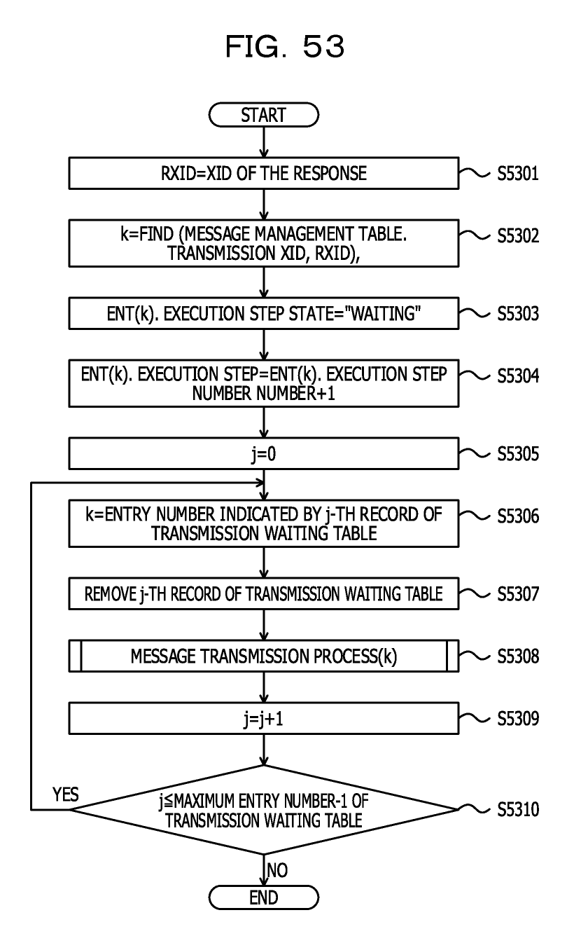

FIG. 53 is a flowchart illustrating an example of the response reception process procedure. The response reception process is a process which is performed when a response is received. The node A sets RXID to the XID of the response (step S5301). Subsequently, the node A sets an entry number, which is acquired using FIND (message management table. transmission XID, RXID), to “k” (step S5302). Here, FIND (message management table. transmission XID, RXID) is a function to compare the transmission XID and RXID of each entry of the message management table m and to output a matching entry number.

Further, the node A sets ENT(k). execution step state to “waiting” (step S5303). Subsequently, the node A increments ENT(k). execution step number (step S5304). Further, the node A sets “j” to “0” (step S5305). Subsequently, the node A sets “k” to the entry number which is indicated by the “j-th” record of the transmission waiting table s (step S5306). Further, the node A removes the “j-th” record of the transmission waiting table s (step S5307). Subsequently, the node A executes the message transmission process for the entry number “k” (step S5308). The message transmission process is the message transmission process illustrated in FIGS. 49 to 51. Here, the node A continues a process using the entry number “k”, which is given as an argument, instead of performing the step in step S4901 in the message transmission process.

After the process in step S5308 ends, the node A increments “j” (step S5309). Subsequently, the node A determines whether or not “j” is equal to or less than “the maximum number of entries-1” of the transmission waiting table s (step S5310). When “j” is equal to or less than “the maximum number of entries-1” of the transmission waiting table s (step S5310: Yes), the node A proceeds to a process in step S5306. In contrast, when “j” is greater than “the maximum number of entries-1” of the transmission waiting table s (step S5310: No), the node A ends the response reception process.

As described above, the node A according to the embodiment stores a reception order of each RPC processing request, which is sequentially received from the client K, and transmits the result of each RPC process to the client K according to the reception order when each RPC process is completed. Therefore, the node A may reduce the time taken for the plural RPC processes while guaranteeing that the order of the plural RPC processes is not changed.

In addition, according to the node A of the embodiment, if a node which executes a certain RPC is the same as an apparatus which is executing a prior RPC, the node executes the RPCs in received sequence. Since it is possible to maintain the execution sequence through exclusive control inside the node to be executed, the node A may immediately execute the certain RPC (RPC which is subsequent to the prior RPC). Therefore, when the process of the prior RPC is superimposed on the process of the certain RPC, the node A may not wait for the response of the prior RPC while maintain the sequence of the prior RPC and the certain RPC, and thus it is possible to rapidly receive the response of the certain RPC.

In addition, according to the node A of the embodiment, if a node executed at the head of the node group which executes the certain RPC is the same as the node which is executing the prior process, the certain RPC may be immediately executed. The reason for this is that the node executes the RPC according to the received sequence, and the execution sequence is maintained through the exclusive control in the executing node. Therefore, the node A may not wait for the response of the prior RPC while maintaining the sequence between the prior RPC and the certain RPC, and thus it is possible to rapidly receive the response of the certain RPC.

In addition, according to the node A of the embodiment, if there is no node, which is included in both a node which is executing a prior process or a first node group which is executed from now on and a second node group which will execute a certain RPC, an RPC included in the second node group may be immediately executed. In this case, since the first node group and the second node group do not interfere with each other, it is possible for the node A to immediately execute a certain RPC and to immediately receive the response of the certain RPC.

In addition, according to the node A of the embodiment, the RPCs may be transmitted to any one of the nodes B, C, . . . using the communication protocol for guaranteeing that data is received according to sequence, in which the data is transmitted. Therefore, since the arrival sequence of the RPCs is not changed in the same destination, it is possible to guarantee the sequence of the plural RPCs. In the same manner, according to the node A of the embodiment, such a communication protocol may be used when the plural RPCs are sequentially received from the client K or when the responses of the RPCs are transmitted to the client K. Therefore, the arrival sequence of the plural RPCs from the client K and the arrival sequence of responses of the RPCs to the client K are not changed.

In addition, according to the distributed processing system 200 of the embodiment, a matching apparatus is the node in the distributed processing system 200. In contrast, when the synchronous execution is performed, the matching apparatus is a client which performs the synchronous execution. In addition, according to the distributed processing system 200, command process superimposition is performed as much as possible, it is possible to reduce latency.

Meanwhile, it is possible to realize the distributed processing method described in the embodiment by executing a previously prepared distributed processing program by a computer such as a personal computer or a workstation. The distributed processing program is recorded in a computer-readable recording medium, such as a hard disk, a flexible disk, a compact disc-read only memory (CD-ROM), a digital versatile disk (DVD), and is executed after being read from the recording medium using by the computer. In addition, the distributed processing program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A distributed processing apparatus comprising:
a memory; and
a processor coupled to the memory and configured to:
store sequence information indicative of a sequence, in which a processing request for each of a plurality of processes is received from a request source apparatus, in the memory when the processing request for each of the plurality of processes is sequentially received from the request source apparatus and one of the distributed processing apparatus and an other apparatus executes each of the plurality of processes, and
transmit a processing result of each of the plurality of processes to the request source apparatus according to the sequence indicated by the sequence information when the one of the distributed processing apparatus and the other apparatus completes each of the plurality of processes.

2. The distributed processing apparatus according to claim 1, wherein the processor is configured to:
transmit the processing request for each of the plurality of processes to the apparatus in response to a reception of the processing request for each of the plurality of processes when an apparatus, which executes a process prior to each of the plurality of processes specified by the sequence information, is the same as the apparatus which executes each of the plurality of processes.

3. The distributed processing apparatus according to claim 1, wherein the processor is configured to:
transmit a processing request for partial processes, which are acquired after distributing each of the plurality of processes, to one apparatus, in response to the reception of the processing request for each of the plurality of processes when one apparatus of first apparatuses, which is executing the distributed partial processes of the first apparatuses which executes a process prior to each of the plurality of processes specified by the sequence information in a distributed manner, is the same as an apparatus which is preemptively executed in second apparatuses which executes each of the plurality of processes in the distributed manner.

4. The distributed processing apparatus according to claim 1, wherein the processor is configured to:
transmit a processing request for partial processes, which are acquired after distributing each of the plurality of processes, to second apparatuses in response to the reception of the processing request for each of the plurality of processes when there is no apparatus which is included in both first apparatuses, which is executing or executes a process prior to each of the plurality of processes specified by the sequence information in a distributed manner, and the second apparatuses which executes each of the plurality of processes in the distributed manner.

5. The distributed processing apparatus according to claim 1, wherein the processor is configured to:
cause the other apparatus to execute each of the plurality of processes by transmitting the processing request for each of the plurality of processes to the other apparatus using a communication protocol for guaranteeing that data is received according to sequence in which the data is transmitted.

6. The distributed processing apparatus according to claim 1, wherein the processor is configured to:
sequentially receive the processing request for each of the plurality of processes from the request source apparatus using a communication protocol for guaranteeing that data is received according to sequence in which the data is transmitted.

7. The distributed processing apparatus according to claim 1, wherein the processor is configured to:
transmit the processing result of each of the plurality of processes to the request source apparatus according to the sequence indicated by the sequence information in response to a fact that one of the distributed processing apparatus and the other apparatus completes each of the plurality of processes using a communication protocol for guaranteeing that data is received according to sequence in which the data is transmitted.

8. The distributed processing apparatus according to claim 1, wherein the processor is configured to:
transmit the processing result of each of the plurality of processes to the request source apparatus when one of the distributed processing apparatus and the other apparatus completes each of the plurality of processes and when a process prior to each of the plurality of processes specified by the sequence information is completed, and
transmit the processing result of each of the plurality of processes to the request source apparatus after transmitting a processing result of the prior process to the request source apparatus according to the completion of the prior process when one of the distributed processing apparatus and other apparatus completes each of the plurality of processes and when the prior process is not completed.

9. A distributed processing system comprising:
a plurality of apparatuses,
wherein a first apparatus of the plurality of apparatus which sequentially received processing request for each of a plurality of processes from a request source apparatus includes a memory and is configured to:
store sequence information indicative of a sequence, in which the processing request for each of the plurality of processes is received from a request source apparatus, in the memory when one of the plurality of apparatus executes each of the plurality of processes, and
transmit a processing result of each of the plurality of processes to the request source apparatus according to the sequence indicated by the sequence information when the one of the plurality of apparatuses completes each of the plurality of processes.

10. The distributed processing system according to claim 9, wherein the first apparatus is configured to:
transmit the processing request for each of the plurality of processes to the apparatus in response to a reception of the processing request for each of the plurality of processes when an apparatus, which executes a process prior to each of the plurality of processes specified by the sequence information, is the same as the apparatus which executes each of the plurality of processes.

11. The distributed processing system according to claim 9, wherein the first apparatus is configured to:
transmit a processing request for partial processes, which are acquired after distributing each of the plurality of processes, to one apparatus, in response to the reception of the processing request for each of the plurality of processes when one apparatus of second apparatuses among the plurality of apparatuses, which is executing the distributed partial processes of the first apparatuses which executes a process prior to each of the plurality of processes specified by the sequence information in a distributed manner, is the same as an apparatus which is preemptively executed in third apparatuses of the plurality of apparatuses which executes each of the plurality of processes in the distributed manner.

12. The distributed processing system according to claim 9, wherein the first apparatus is configured to:
transmit a processing request for partial processes, which are acquired after distributing each of the plurality of processes, to third apparatuses of the plurality of apparatuses in response to the reception of the processing request for each of the plurality of processes when there is no apparatus which is included in both second apparatuses of the plurality of apparatuses, which is executing or executes a process prior to each of the plurality of processes specified by the sequence information in a distributed manner, and the third apparatuses which executes each of the plurality of processes in the distributed manner.

13. The distributed processing system according to claim 9, wherein the first apparatus is configured to:
cause another apparatus to execute each of the plurality of processes by transmitting the processing request for each of the plurality of processes to a second apparatus of the plurality of apparatuses using a communication protocol for guaranteeing that data is received according to sequence in which the data is transmitted.

14. The distributed processing system according to claim 9, wherein the first apparatus is configured to:
sequentially receive the processing request for each of the plurality of processes from the request source apparatus using a communication protocol for guaranteeing that data is received according to sequence in which the data is transmitted.

15. The distributed processing system according to claim 9, wherein the first apparatus is configured to:
transmit the processing result of each of the plurality of processes to the request source apparatus according to the sequence indicated by the sequence information in response to a fact that the one of the plurality of apparatuses completes each of the plurality of processes using a communication protocol for guaranteeing that data is received according to sequence in which the data is transmitted.

16. The distributed processing system according to claim 9, wherein the first apparatus is configured to:
transmit the processing result of each of the plurality of processes to the request source apparatus when the one of the plurality of apparatuses completes each of the plurality of processes and when a process prior to each of the plurality of processes specified by the sequence information is completed, and
transmit the processing result of each of the plurality of processes to the request source apparatus after transmitting a processing result of the prior process to the request source apparatus according to the completion of the prior process when the one of the plurality of apparatuses completes each of the plurality of processes and when the prior process is not completed.

17. A non-transitory storage medium that stores a program for causing an apparatus of a plurality of apparatuses to execute a process of distributed processing, the process of distributed processing comprising:
storing sequence information indicative of a sequence, in which a processing request for each of a plurality of processes is received from a request source apparatus, in a memory when the processing request for each of the plurality of processes is sequentially received from the request source apparatus and one of the plurality of apparatuses executes each of the plurality of processes; and
transmitting a processing result of each of the plurality of processes to the request source apparatus according to the sequence indicated by the sequence information when the one of the plurality of apparatuses completes each of the plurality of processes.

18. The non-transitory storage medium according to claim 17, the process of distributed processing further comprising:
transmitting the processing request for each of the plurality of processes to the apparatus in response to a reception of the processing request for each of the plurality of processes when an apparatus, which executes a process prior to each of the plurality of processes specified by the sequence information, is the same as the apparatus which executes each of the plurality of processes.

19. The non-transitory storage medium according to claim 17, the process of distributed processing further comprising:
transmitting a processing request for partial processes, which are acquired after distributing each of the plurality of processes, to one apparatus, in response to the reception of the processing request for each of the plurality of processes when one apparatus of first apparatuses among the plurality of apparatuses, which is executing the distributed partial processes of the first apparatuses which executes a process prior to each of the plurality of processes specified by the sequence information in a distributed manner, is the same as an apparatus which is preemptively executed in second apparatuses of the plurality of apparatuses which executes each of the plurality of processes in the distributed manner.

20. The non-transitory storage medium according to claim 17, the process of distributed processing further comprising:
transmitting a processing request for partial processes, which are acquired after distributing each of the plurality of processes, to second apparatuses of the plurality of apparatuses in response to the reception of the processing request for each of the plurality of processes when there is no apparatus which is included in both first apparatuses of the plurality of apparatuses, which is executing or executes a process prior to each of the plurality of processes specified by the sequence information in a distributed manner, and the second apparatuses which executes each of the plurality of processes in the distributed manner.
